(19) United States
(12) Patent Application Publication
(10) Pub. No.: US 2017/0231408 A1
(43) Pub. Date: Aug. 17, 2017

(54) BLANKET WITH REMOVABLE SOFT AND FLEXIBLE BOOK

(71) Applicant: Simcha Brown, Cedarhurst, NY (US)

(72) Inventor: Simcha Brown, Cedarhurst, NY (US)

(21) Appl. No.: 15/379,477

(22) Filed: Dec. 14, 2016

Related U.S. Application Data
(60) Provisional application No. 62/267,788, filed on Dec. 15, 2015.

(51) Int. Cl. A47G 9/02; B42D 1/00; B42D 3/02

(52) U.S. Cl. CPC A47G 9/0207; B42D 3/02; B42D 1/008

(57) ABSTRACT

Various entertainment systems, that include a blanket, along with a flexible book that is removably attachable to the blanket, are described. Such flexible books may include a flexible cover and disposed within the flexible cover may be at least one flexible page. The flexible book may be constructed from a fabric. In some embodiments, the blanket may comprise at least one pocket for removable storage of the flexible book. In some embodiments, the blanket may be folded in half, creating a folder, wherein this folder may be used to removably store the flexible book. And irrespective of such flexible book storage with the blanket, the flexible book may be removably attached to the blanket using mechanical fasteners. Additionally, methods of use and methods of manufacturing for such blankets and flexible books are described, disclosed, and taught.

### PRIORITY NOTICE

The present application claims priority under 35 U.S.C. §119(e) to U.S. Provisional Patent Application Ser. No. 62/267,788 filed on Dec. 15, 2015, the disclosure of which is incorporated herein by reference in its entirety.

### TECHNICAL FIELD OF THE INVENTION

The present invention relates in general to fabric and/or textile blankets for comfort and/or warmth as well as flexible books and more specifically to fabric and/or textile blankets for comfort and/or warmth that are combined with a removable soft and flexible book.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Presently, the prior art does not teach a combination of a soft and warm blanket that may provide storage means for storing a flexible book; wherein such a flexible book may also be removably attached to the blanket, such that this blanket and this removably attachable flexible book may associate together as an entertainment system.

It is to these ends that the present invention has been developed.

### BRIEF SUMMARY OF THE INVENTION

To minimize the limitations in the prior art, and to minimize other limitations that will be apparent upon reading and understanding the present specification, the present invention describes various entertainment systems, wherein such entertainment systems may comprise a blanket, along with a flexible book; wherein the flexible book may be removably attached to the blanket. Such flexible books may comprise a flexible cover and disposed within the flexible cover may be at least one flexible page (i.e., one or more flexible pages). In some embodiments, the blanket may be folded in half, creating a folder, wherein this folder may be used to removably store the flexible book. In some embodiments, the blanket may comprise at least one pocket for removable storage of the flexible book. And irrespective of such flexible book storage with the blanket, the flexible book may be removably attached to the blanket. Additionally, methods of use and methods of manufacturing may be described, disclosed, and taught.

It is an objective of the present invention to provide a warm and/or comfortable blanket that may be removably attached to a soft flexible book.

It is another objective of the present invention to provide a flexible book that may be removably attached to a blanket, as to the two may not become easily separated or lost with respect to each other.

It is another objective of the present invention to provide means for storing flexible books with blankets.

It is yet another objective of the present invention to provide an entertainment system that may combine a warm and/or comfortable blanket with a removable flexible book, such as a fabric book; wherein this flexible book may be removably attached to this blanket.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict an embodiment of a blanket housing a removable book from a top perspective view.

FIG. 2 may depict the embodiment of FIG. 1 and a same operational configuration shown in FIG. 1, wherein FIG. 2 may be shown from a top view.

FIG. 3 may depict the embodiment of FIG. 1 and the same operational configuration shown in FIG. 1, wherein FIG. 3 may be shown from a bottom view. FIG. 3 may be an opposing view to FIG. 2.

FIG. 4 may depict the embodiment of FIG. 1 and the same operational configuration shown in FIG. 1, wherein FIG. 4 may be shown from a front view (i.e., a pocket access view).

FIG. 5 may depict the embodiment of FIG. 1 and the same operational configuration shown in FIG. 1, wherein FIG. 5 may be shown from a back view. FIG. 5 may be an opposing view to FIG. 4.

FIG. 6 may depict the embodiment of FIG. 1 and the same operational configuration shown in FIG. 1, wherein FIG. 6 may be shown from a side view (left-side or right-side view due to symmetry).

FIG. 7 may depict the embodiment of FIG. 1, but from a different operational configuration as shown in FIG. 1, wherein FIG. 7 may be shown from the front view with a pocket open. In comparison, in FIG. 4, this pocket may be shown in a (substantially) closed configuration.

FIG. 8 may depict the embodiment of FIG. 1, but from a different operational configuration as shown in FIG. 1 (and different from FIG. 7); wherein in FIG. 8, the removable book may be shown removed from the pocket, but still attached to the blanket, shown from a top perspective view. Note FIG. 8 may also include a sectional-line 28-28 wherein a longitudinal-cross-sectional view from this sectional-line may be shown in FIG. 28.

FIG. 9 may depict the embodiment of FIG. 1 and the operational configuration shown in FIG. 8, wherein FIG. 9 may be shown from a top view.

FIG. 10 may depict the embodiment of FIG. 1 and the operational configuration shown in FIG. 8, wherein FIG. 10 may be shown from a bottom view. FIG. 10 may be an opposing view to FIG. 9.

FIG. 11 may depict the embodiment of FIG. 1 and the operational configuration shown in FIG. 8, wherein FIG. 11 may be shown from a front view (i.e., a pocket access view).

FIG. 12 may depict the embodiment of FIG. 1 and the operational configuration shown in FIG. 8, wherein FIG. 12 may be shown from a left-side view.

FIG. 13 may depict the embodiment of FIG. 1 and the operational configuration shown in FIG. 8, wherein FIG. 12 may be shown from a right-side view. FIG. 13 may be an opposing view to FIG. 12.

FIG. 14 may depict the embodiment of FIG. 1, but from a different operational configuration as shown in FIG. 1 (and different from FIG. 7 and different from FIG. 8); wherein in FIG. 14, the removable book may be shown removed from the pocket, and removably detached from the blanket, shown from a top perspective view.

FIG. 15 may depict the embodiment of FIG. 1 and the operational configuration shown in FIG. 14, wherein FIG. 15 may be shown from a top view.

FIG. 16 may depict the embodiment of FIG. 1 and the operational configuration shown in FIG. 14, wherein FIG. 16 may be shown from a bottom view. FIG. 16 may be an opposing view to FIG. 15.

FIG. 17 may depict the embodiment of FIG. 1 and the operational configuration shown in FIG. 14, wherein FIG. 17 may be shown from a front view (i.e., the pocket access view).

FIG. 18 may depict the embodiment of FIG. 1 and the operational configuration shown in FIG. 14, wherein FIG. 18 may be shown from a back view. FIG. 18 may be an opposing view to FIG. 17.

FIG. 19 may depict the embodiment of FIG. 1 and the operational configuration shown in FIG. 14, wherein FIG. 19 may be shown from a left-side view.

FIG. 20 may depict the embodiment of FIG. 1 and the operational configuration shown in FIG. 14, wherein FIG. 20 may be shown from a right-side view. FIG. 20 may be an opposing view to FIG. 19.

FIG. 21 may depict the embodiment of FIG. 1, but from a different operational configuration as shown in FIG. 1 (and different from FIG. 7 and different from FIG. 8 and different from FIG. 14); wherein in FIG. 21, the removable book may be shown removed from the pocket, the book may be removably detached from the blanket, and the book may be open, shown from a top perspective view.

FIG. 22 may depict the embodiment of FIG. 1 and the operational configuration shown in FIG. 21, wherein FIG. 22 may be shown from a top view.

FIG. 23 may depict the embodiment of FIG. 1 and the operational configuration shown in FIG. 21, wherein FIG. 23 may be shown from a bottom view. FIG. 23 may be an opposing view to FIG. 22.

FIG. 24 may depict the embodiment of FIG. 1 and the operational configuration shown in FIG. 21, wherein FIG. 24 may be shown from a front view (i.e., the pocket access view).

FIG. 25 may depict the embodiment of FIG. 1 and the operational configuration shown in FIG. 21, wherein FIG. 25 may be shown from a back view. FIG. 25 may be an opposing view to FIG. 24.

FIG. 26 may depict the embodiment of FIG. 1 and the operational configuration shown in FIG. 21, wherein FIG. 26 may be shown from a left-side view.

FIG. 27 may depict the embodiment of FIG. 1 and the operational configuration shown in FIG. 21, wherein FIG. 27 may be shown from a right-side view. FIG. 27 may be an opposing view to FIG. 26.

FIG. 28 may depict a longitudinal-cross-section of the embodiment of FIG. 1 along sectional-line 28-28 that was shown in FIG. 8.

FIG. 29 may depict an embodiment of a blanket housing a removable book from a top perspective view. The embodiment shown in FIG. 29 may be different from the embodiment of FIG. 1 through FIG. 28.

FIG. 30 may depict the embodiment of FIG. 29 and a same operational configuration shown in FIG. 29, wherein FIG. 30 may be shown from a top view.

FIG. 31 may depict the embodiment of FIG. 29 and the same operational configuration shown in FIG. 29, wherein FIG. 31 may be shown from a bottom view. FIG. 31 may be an opposing view to FIG. 30.

FIG. 32 may depict the embodiment of FIG. 29 and the same operational configuration shown in FIG. 29, wherein FIG. 32 may be shown from a front view (or from a back view, which may be substantially symmetrical to the front view).

FIG. 33 may depict the embodiment of FIG. 29 and the same operational configuration shown in FIG. 29, wherein FIG. 33 may be a left-side view.

FIG. 34 may depict the embodiment of FIG. 29 and the same operational configuration shown in FIG. 29, wherein FIG. 34 may be a right-side view. FIG. 34 may be an opposing view to FIG. 33.

FIG. 35 may depict the embodiment of FIG. 29, but from a different operational configuration as shown in FIG. 29; wherein in FIG. 35, the blanket may be unfolded into an open blanket configuration showing the book, wherein the book may be in a closed configuration, shown from a top perspective view.

FIG. 36 may depict the embodiment of FIG. 29 and the operational configuration of FIG. 35, wherein FIG. 36 may be shown from a top view.

FIG. 37 may depict the embodiment of FIG. 29 and the operational configuration of FIG. 35, wherein FIG. 37 may be shown from a bottom view. FIG. 37 may be an opposing view to FIG. 36.

FIG. 38 may depict the embodiment of FIG. 29 and the operational configuration of FIG. 35, wherein FIG. 38 may be shown from a front view (or from a back view, which may be substantially symmetrical to the front view).

FIG. 39 may depict the embodiment of FIG. 29 and the operational configuration of FIG. 35, wherein FIG. 39 may be a left-side view.

FIG. 40 may depict the embodiment of FIG. 29 and the operational configuration of FIG. 35, wherein FIG. 40 may be a right-side view. FIG. 40 may be an opposing view to FIG. 39.

FIG. 41 may depict the embodiment of FIG. 29, but from a different operational configuration as shown in FIG. 35 (and different from FIG. 29); wherein in FIG. 41, the blanket may be unfolded into an open blanket configuration showing the book, wherein the book may be in an open configuration, shown from a top perspective view.

FIG. 42 may depict the embodiment of FIG. 29 and the operational configuration of FIG. 41, wherein FIG. 42 may be shown from a top view.

FIG. 43 may depict the embodiment of FIG. 29 and the operational configuration of FIG. 41, wherein FIG. 43 may be shown from a bottom view. FIG. 43 may be an opposing view to FIG. 42.

FIG. 44 may depict the embodiment of FIG. 29 and the operational configuration of FIG. 41, wherein FIG. 44 may be shown from a front view (or from a back view, which may be substantially symmetrical to the front view).

FIG. 45 may depict the embodiment of FIG. 29 and the operational configuration of FIG. 41, wherein FIG. 45 may be a side view (either a left-side view or a right-side view due to symmetry).

FIG. 46 may depict a top view similar to that of FIG. 36 or of FIG. 42, but in FIG. 46 the book may not be shown.

FIG. 47 may depict a bottom (exterior) cover of the book of FIG. 29 through FIG. 45.

FIG. 48 may depict another bottom (exterior) cover of the book of FIG. 29 through FIG. 45.

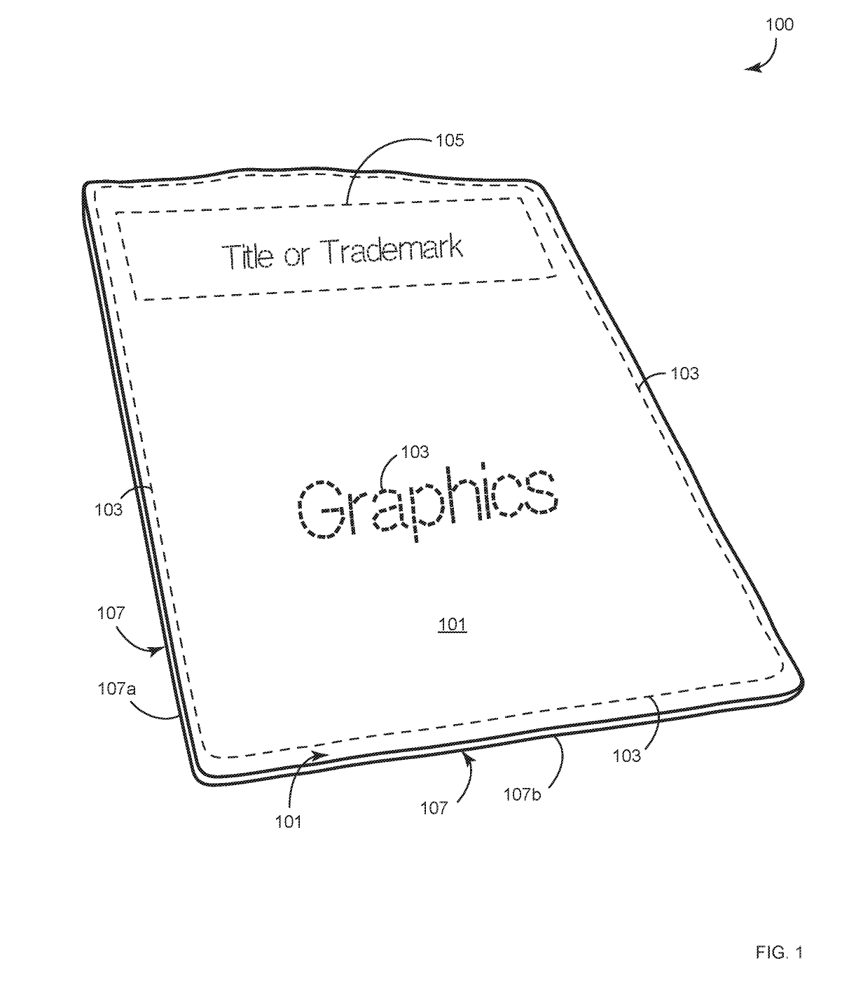

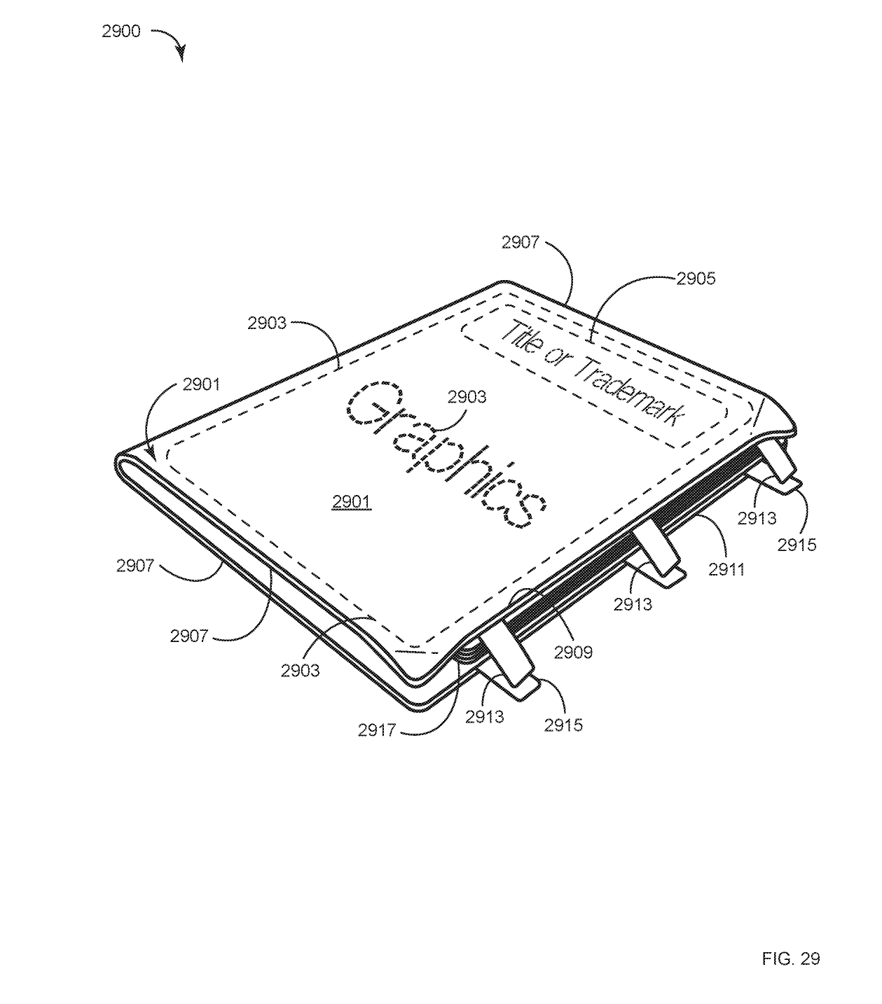

Note, FIG. 1 through FIG. 28 may depict the same embodiment, but may depict different operational configurations of that embodiment. Similarly, FIG. 29 through FIG. 46 may depict a same embodiment, but a different embodiment from FIG. 1 through FIG. 28; however, this same embodiment of FIG. 29 through FIG. 46 may show different operational configurations.

### REFERENCE NUMERALS

100 blanket 100
101 top-exterior-layer 101
103 display-region 103
105 title-display-region 105
107 edge 107
107a long-edge 107a
107b short-edge 107b
309 bottom-exterior-layer 309
311 length 311
313 width 313
415 pocket 415
417 pocket-opening 417
419 pocket-sealer 419
621 pocket-region 621
723 soft-and-flexible-book 723
825 flexible-top-cover 825
827 book-binding 827
829 flexible-page 829
831 graphics 831
833 tether 833
1035 flexible-bottom-cover 1035
1437 fastener-on-tether 1437
1639 fastener-on-book 1639
2841 blanket-interior 2841
2843 pocket-cavity 2843
2845 terminal-end 2845
2900 blanket 2900
2901 top-exterior-layer 2901
2903 display-region 2903
2905 title-display-region 2905
2907 edge 2907
2909 first-terminal-edge 2909
2911 second-terminal-edge 2911
2913 flap 2913
2915 complimentary-flap 2915
2917 soft-and-flexible-book 2917
3019 folded-edge 3019
3521 inside-exterior-surface 3521
3523 book-binding 3523
3525 flexible-top-cover 3525
3527 flexible-page 3527
3529 graphics 3529
4631 blanket-to-book-fastener 4631
4733 flexible-bottom-cover 4733
4735 book-to-blanket-fastener 4735
4837 book-to-blanket-fastener 4837
4839 book-to-blanket-fastener 4839

### DETAILED DESCRIPTION OF THE INVENTION

This disclosure describes, discloses, and teaches various entertainment systems, wherein such entertainment systems may comprise a blanket, along with a flexible book; wherein the flexible book may be removably attached to the blanket. Such flexible books may comprise a flexible cover (top and bottom) and disposed within that flexible cover may be at least one flexible page (i.e., one or more flexible pages). In some embodiments, the blanket may comprise at least one pocket for removable storage of the flexible book. In some embodiments, the blanket may be folded in half, creating a folder, wherein this folder may be used to removably store (house) the flexible book. And irrespective of such flexible book storage (housing) with the blanket, the flexible book may be removably attached to the blanket. Additionally, methods of use and methods of manufacturing may be described, disclosed, and taught.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

In some embodiments, FIG. 1 through FIG. 28 may depict an entertainment system. In some embodiments, this entertainment system may comprise a blanket 100 with a removable soft-and-flexible-book 723, wherein soft-and-flexible-book 723 may be removably attached to blanket 100.

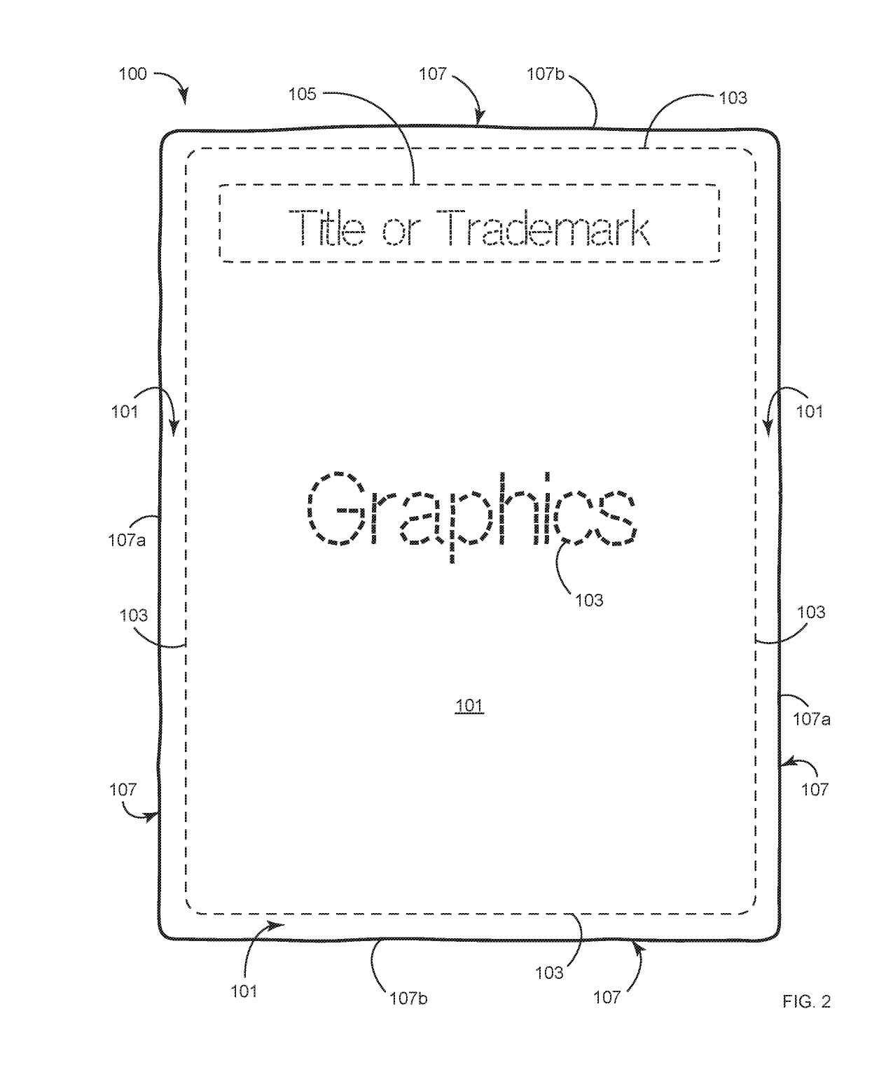

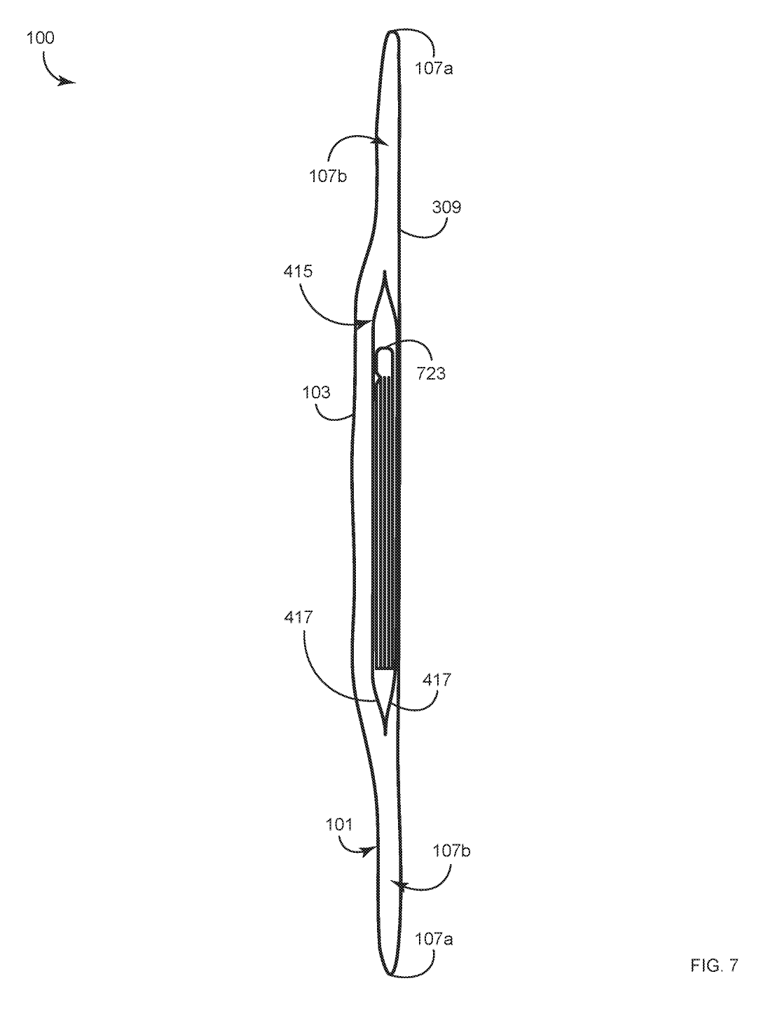

FIG. 1 may depict an embodiment of blanket 100 housing a removable book 723 (e.g., soft-and-flexible-book 723 first partially shown in FIG. 7) from a top perspective view. FIG. 2 may depict blanket 100, shown from a top view. FIG. 2 and FIG. 1 may be depict a same operational configuration of blanket 100; i.e., of blanket 100 removably housing soft-and-flexible-book 723 inside a pocket 415; wherein pocket 415 and soft-and-flexible-book 723 may not be visible in FIG. 1 nor in FIG. 2.

In some embodiments, blanket 100 may be substantially soft, flexible, and a planar member comprising two opposing major surfaces, a top-exterior-layer 101 and an opposing bottom-exterior-layer 309; wherein these two opposing major surfaces may be substantially bound by an edge 107 that may substantially circumscribes a periphery of blanket 100. In some embodiments, soft-and-flexible-book 723 may comprising a flexible-top-cover 825, a flexible-bottom-cover 1035, one or more flexible-pages 829, and a book-binding 827; wherein flexible-top-cover 825, the one or more flexible-pages 829, and flexible-bottom-cover 1035 may be attached to book-binding 827; wherein the one or more flexible-pages 829 may be disposed between flexible-top-cover 825 and flexible-bottom-cover 1035; wherein the flexible-top-cover 825 and flexible-bottom-cover 1035 may be opposing each other. The soft-and-flexible-book 723 may be removably attached to blanket 100.

In some embodiments, blanket 100 may be a blanket for providing warmth and/or comfort to a user. In some embodiments, blanket 100 may be substantially comprised of one or more types of soft fabrics and/or textiles. Such fabrics and/or textiles may be natural and/or synthetic, or blends thereof. Blanket 100 may be one ply in some embodiments to multiple ply in other embodiments. In terms of size, in some embodiments, blanket 100 may be sized as a throw and/or sized to function as a bedspread for a standard sized bed, such as but not limited to, a single bed, a twin bed, a full size bed, a queen sized bed, a kind sized bed, a California king sized bed, and the like. In some embodiments, blanket 100 may be substantially flexible and/or pliable, such that blanket 100 may naturally, via gravity, drape over portions of the user when blanket 100 may be disposed over portions of the user 100. That is, in some embodiments, blanket 100 may not be rigid nor semi-rigid. That is, blanket 100 may be more flexible and more pliable than a throw pillow or a head pillow used for sleeping.

In some embodiments, blanket 100 may be a substantially flexible, pliable, and planar member. When blanket 100 may be laying upon a substantially flat substrate, blanket 100 as viewed from above, may be one of the following shapes: a regular polygon, with rounded or without rounded corners; an irregular polygon with rounded or without rounded corners; a square with rounded or without rounded corners; a rectangle with or without rounded corners; an oval; an ellipse, a circle; a semi-circle; and the like. Such shapes may be bounded by edges 107. See e.g., FIG. 2. In some embodiments, this shape of a given blanket 100 may be determined so as to best fit a given bed shape, which may generally be rectangular.

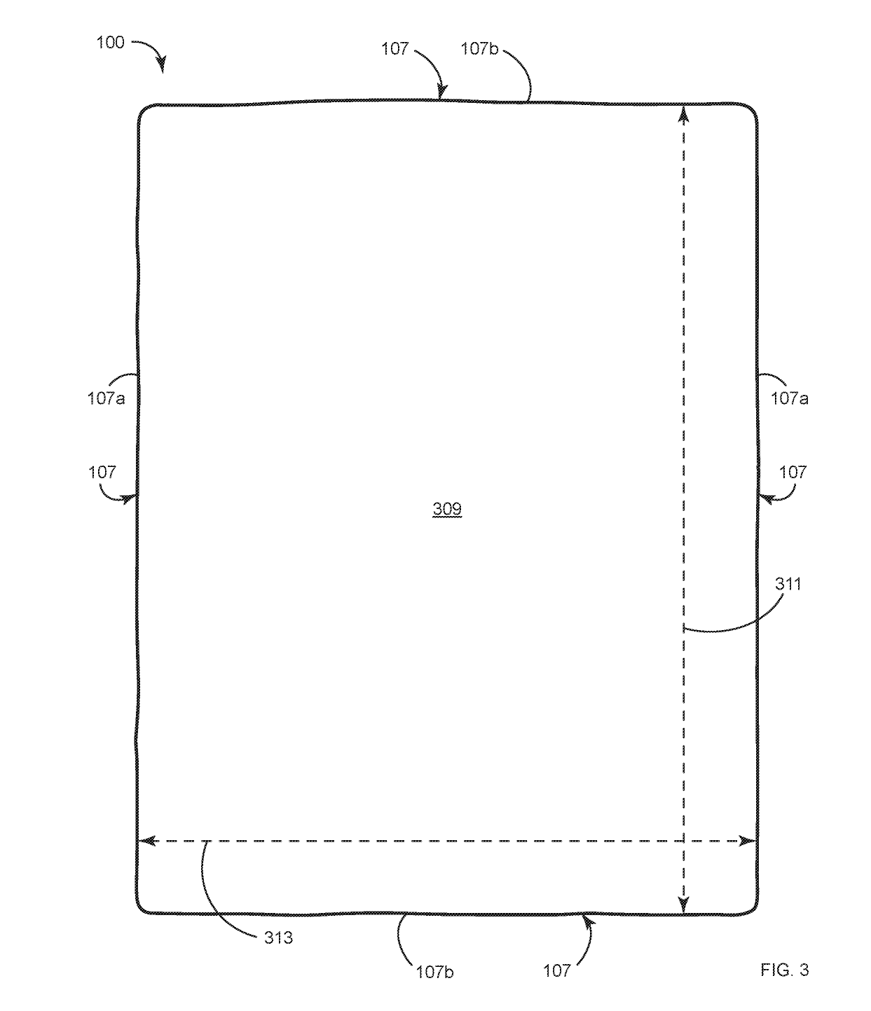

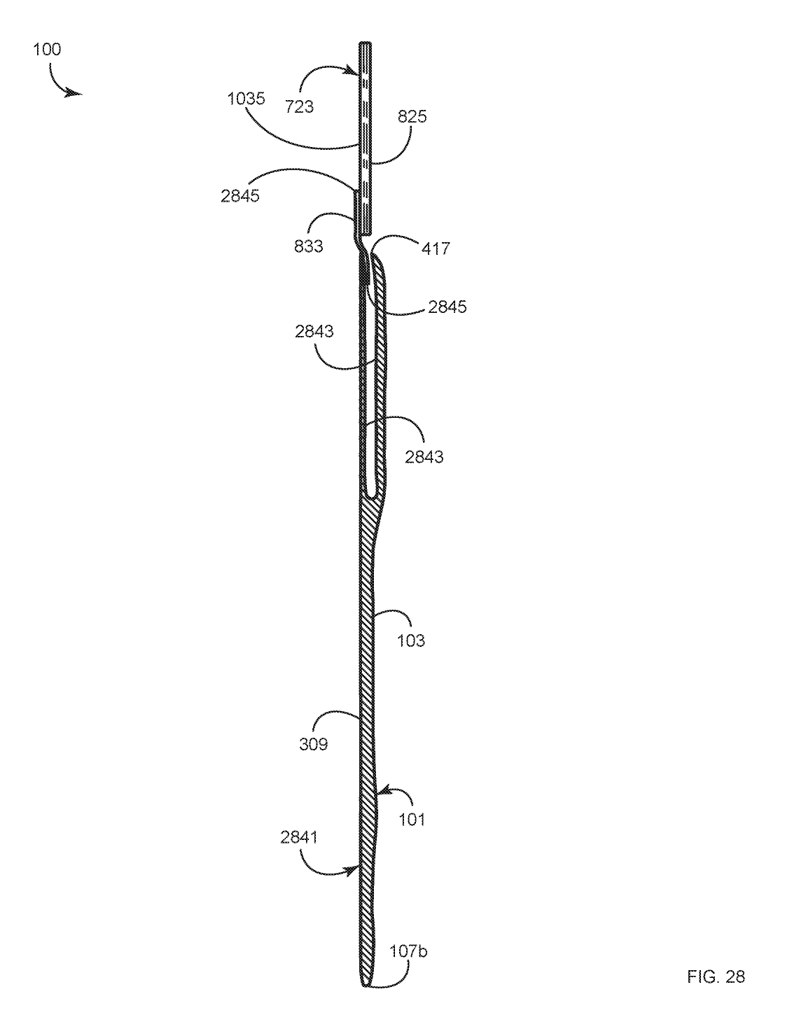

Discussing FIG. 1 and FIG. 2, in some embodiments, blanket 100 may comprise a top-exterior-layer 101 and disposed opposite a bottom-exterior-layer 309 (see FIG. 3 for bottom-exterior-layer 309). In some embodiments, top-exterior-layer 101 and bottom-exterior-layer 309 may face opposite directions when blanket 100 may be in a substantially planar configuration; e.g., when blanket 100 may be a two ply blanket, constructed from two sheets of fabric sealed together around edges 107 of blanket 100. That is, a seam may run substantially around a periphery of edges 107 sealing one layer (e.g., top-exterior-layer 101) to another layer (e.g., bottom-exterior-layer 309), except where at least one pocket-opening 417 to at least one pocket 415 may be located. In some embodiments, at least one pocket 415 may be disposed between top-exterior-layer 101 and bottom-exterior-layer 309 (see e.g., FIG. 28). In some embodiments, bottom-exterior-layer 309 may be softer than top-exterior-layer 101.

Continuing discussing FIG. 1 and FIG. 2, in some embodiments, blanket 100 may comprise edge 107 wherein edge 107 may form a perimeter (e.g., outside edge) around blanket 100. In some embodiments, wherein blanket 100 may have a substantially rectangular shape, when blanket 100 may be in the planar configuration of FIG. 1 and FIG. 2, then edge 107 may comprise a pair of opposing and substantially parallel long-edges 107a; as well as a pair of opposing and substantially parallel short-edges 107b. In some embodiments, one long-edge 107a may connect to one short-edge 107b; wherein this sort-edge 107b may then connect to the remaining long-edge 107a; and that long-edge 107a may then connect to the remaining short-edge 107b, such these pair of long-edges 107a and pair of short-edges 107b form the substantially rectangular shape, when blanket 100 may be in the planar configuration.

Continuing discussing FIG. 1 and FIG. 2, in some embodiments, top-exterior-layer 101 may comprise a top exterior surface. Likewise, in some embodiments, bottom-exterior-layer 309 may comprise a bottom exterior surface. When assembled, respective (and inherent) interior surfaces of both top-exterior-layer 101 and bottom-exterior-layer 309 may be substantially facing each other. In some embodiments, this top exterior surface may be disposed opposite of this bottom exterior surface; wherein the top exterior surface and the bottom exterior surface may face opposite directions when blanket 100 may be in the substantially planar configuration. In some embodiments, this top exterior surface may comprise a display-region 103. In some embodiments, top-exterior-layer 101 may comprise display-region 103. See e.g., FIG. 1 and FIG. 2. In some embodiments, this display-region 103 may display one or more of: a graphic, a scene, a landscape, a logo, a trademark, an image, wording, a copy of a book cover, title-display-region 105 and/or the like. In some embodiments, display-region 103 may cover: a majority of the top exterior surface, half of the top exterior surface, or less than half of the top exterior surface. In some embodiments, display-region 103 may cover: a majority of top-exterior-layer 101, half of top-exterior-layer 101, or less than half of top-exterior-layer 101. For example, in FIG. 1 and FIG. 2, where display-region 103 may cover the majority of the top exterior surface of top-exterior-layer 101.

Continuing discussing FIG. 1 and FIG. 2, in some embodiments, top-exterior-layer 101 may comprise display-region 103. In some embodiments, display-region 103 may comprise title-display-region 105; wherein title-display-region 105 may be a region of display-region 103 wherein a title and/or a trademark may be displayed. In some embodiments, top-exterior-layer 101 may comprise title-display-region 105; wherein title-display-region 105 may be a region of top-exterior-layer 101 wherein a title and/or a trademark may be displayed.

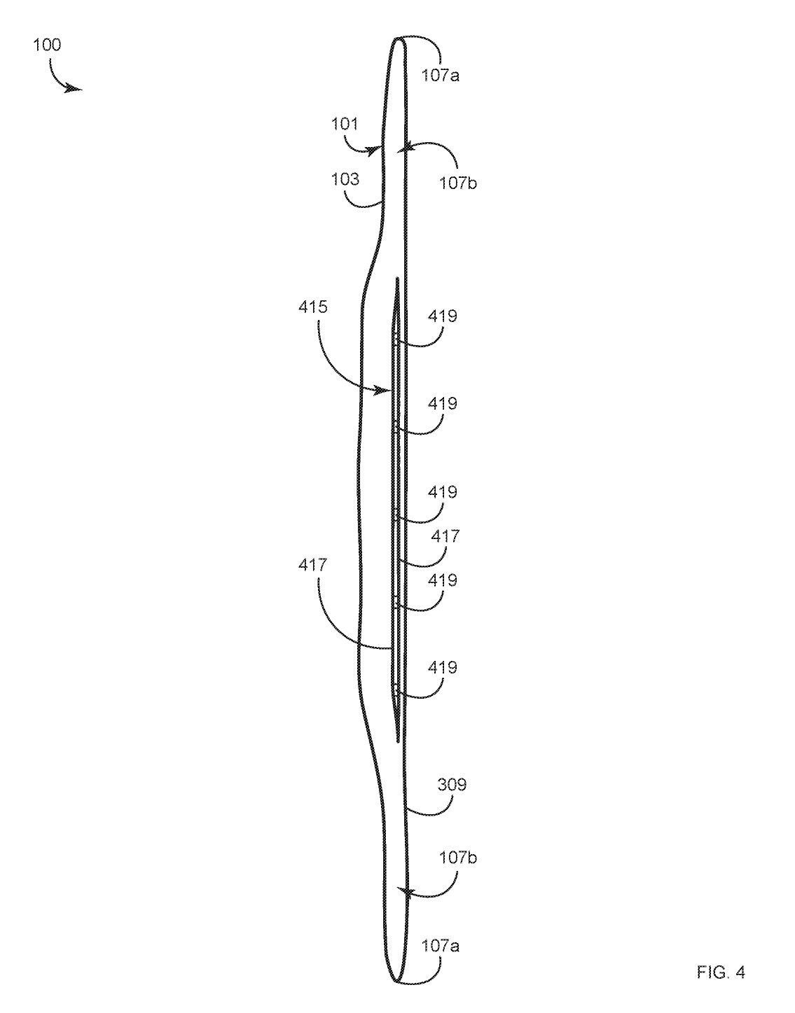

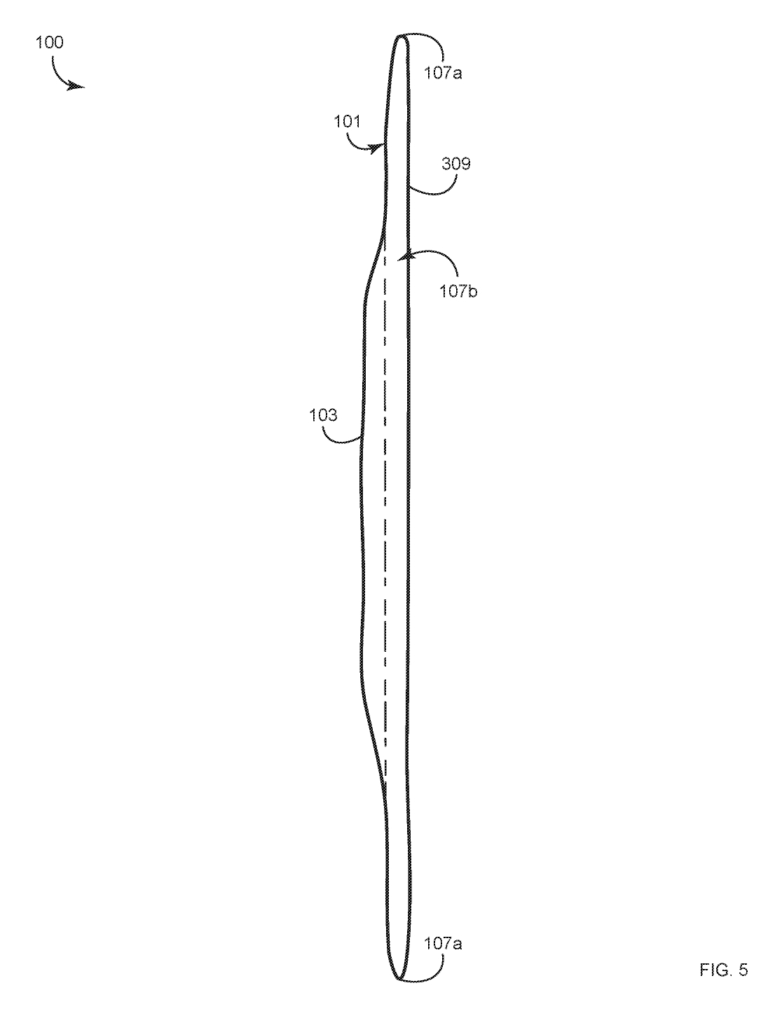

FIG. 3 may depict blanket 100 from a bottom view. FIG. 3 may be an opposing view to FIG. 2. FIG. 3, FIG. 2 and FIG. 1 may be depict the same operational configuration of blanket 100; i.e., of the planar configuration. FIG. 3 may depict bottom-exterior-layer 309 of blanket 100. In some embodiments, bottom-exterior-layer 309 may be opposing top-exterior-layer 101. In some embodiments, a major surface of bottom-exterior-layer 309 may be substantially parallel to a major surface of top-exterior-layer 101 (see e.g., FIG. 4 and FIG. 5). Structurally and functionally, bottom-exterior-layer 309 may be substantially equivalent to top-exterior-layer 101.

FIG. 3 may also depict length 311 of blanket 100 and width 313 of blanket 100. In some embodiments, the pair of opposing and substantially parallel long-edges 107a may be may be separated from each other by width 313. In some embodiments, the pair of opposing and substantially parallel short-edges 107b may be may be separated from each other by length 311. In some embodiments, length 311 may be about 92 inches, wherein about may be plus or minus 12 inches. In some embodiments, width 313 may be about 60 inches, wherein about may be plus or minus 12 inches. In some embodiments a ratio of length-to-width of blanket 100 may be from 1.1 to 2.2. However, also note, in other embodiments, blanket 100 may be other dimensions, e.g., sized to fit a given standard sized bed.

In some embodiments, the two opposing major surfaces of blanket 100 (e.g., top-exterior-layer 101 and bottom-exterior-layer 309) may be a shape that may be substantially rectangular as viewed orthogonally from above or from below of either of the two opposing major surfaces; wherein these two opposing major surfaces comprise length 311 and width 313 defining dimensions of the shape; wherein a ratio of length-to-width of blanket 100 may be selected from a range of 1.1 to 2.2, including endpoints of that ratio range. In other embodiments, the range for this ratio may be 1.40 to 1.50.

FIG. 4 may depict blanket 100 from a front view (i.e., a pocket access view). In FIG. 4, portions of pocket 415 may be seen, such as at least one pocket-opening 417. A remainder of pocket 415 not shown in FIG. 4 may extend longitudinally within blanket 100, i.e., in a direction of length 311. See e.g., FIG. 28 which pay depict portions of pocket-cavity 2843. In some embodiments, blanket 100 may comprise at least one pocket 415. In some embodiments, at least one pocket 415 may be substantially disposed between top-exterior-layer 101 and bottom-exterior-layer 309. In some embodiments, at least one pocket 415 may comprise at least one pocket-opening 417. In some embodiments, at least one pocket-opening 417 may be located and accessible from edge 107. In some embodiments, at least one pocket-opening 417 may be located and accessible from short-edge 107b. In some embodiments, at least one pocket-opening 417 may comprise pocket-sealer 419. In some embodiments, 419 may be one or types of removable fasteners for removably closing at least one pocket 415. In some embodiments, 419 may be one or types of removable fasteners selected from: buttons, Velcro (i.e., plurality of hooks and complimentary plurality of loops to removably attach to the plurality of hooks), zippers, ties, snap buttons, press buttons, zip-locks, press-fits, and/or the like. In some embodiments, pocket 415 may substantially bound a volume for removably housing soft-and-flexible-book 723. This volume may be defined by pocket-cavity 2843; wherein FIG. 28 may show a cross-section of this pocket-cavity 2843.

FIG. 5 may depict blanket 100 from a back view. FIG. 5 may be an opposing view to FIG. 4.

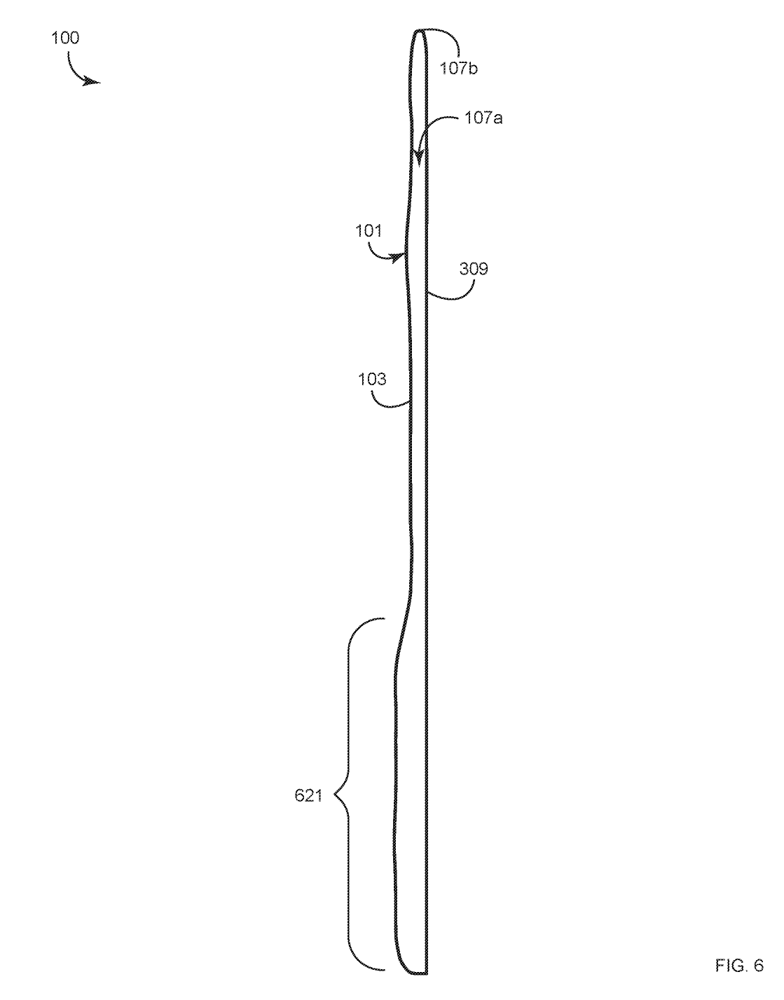

FIG. 6 may depict blanket 100 shown from a side view (which may be a left-side view or a right-side view due to substantial symmetry between the left-side view and the right-side view when soft-and-flexible-book 723 may be removably housed within pocket 415). In FIG. 6, top-exterior-layer 101 may be shown opposing bottom-exterior-layer 309. FIG. 6 may also depict pocket-region 621. In some embodiments, pocket-region 621 may be a region of blanket 100 where at least one pocket 415 resides within blanket 100, disposed between portions top-exterior-layer 101 and bottom-exterior-layer 309.

FIG. 7 may depict blanket 100, but from a different operational configuration as shown in FIG. 1, wherein in FIG. 7 blanket 100 may be shown from the front view with at least one pocket 415 open. In comparison, in FIG. 4 at least one pocket 415 may be shown in a (substantially) closed configuration. In FIG. 7, at least one pocket-opening 417 may be open. In FIG. 7, pocket-sealers 419 may be removably disconnected from each other to permit opening of at least one pocket-opening 417. Because at least one pocket-opening 417 may be open in FIG. 7, a portion of soft-and-flexible-book 723 removably housed within at least one pocket 415 may be seen.

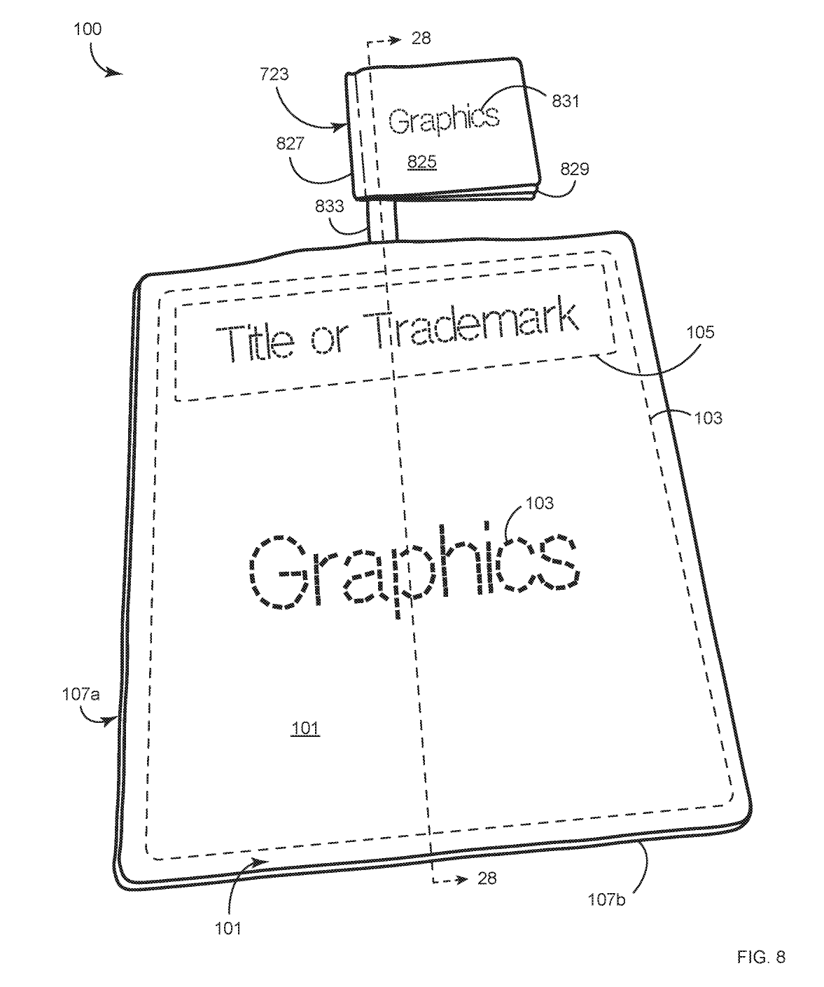

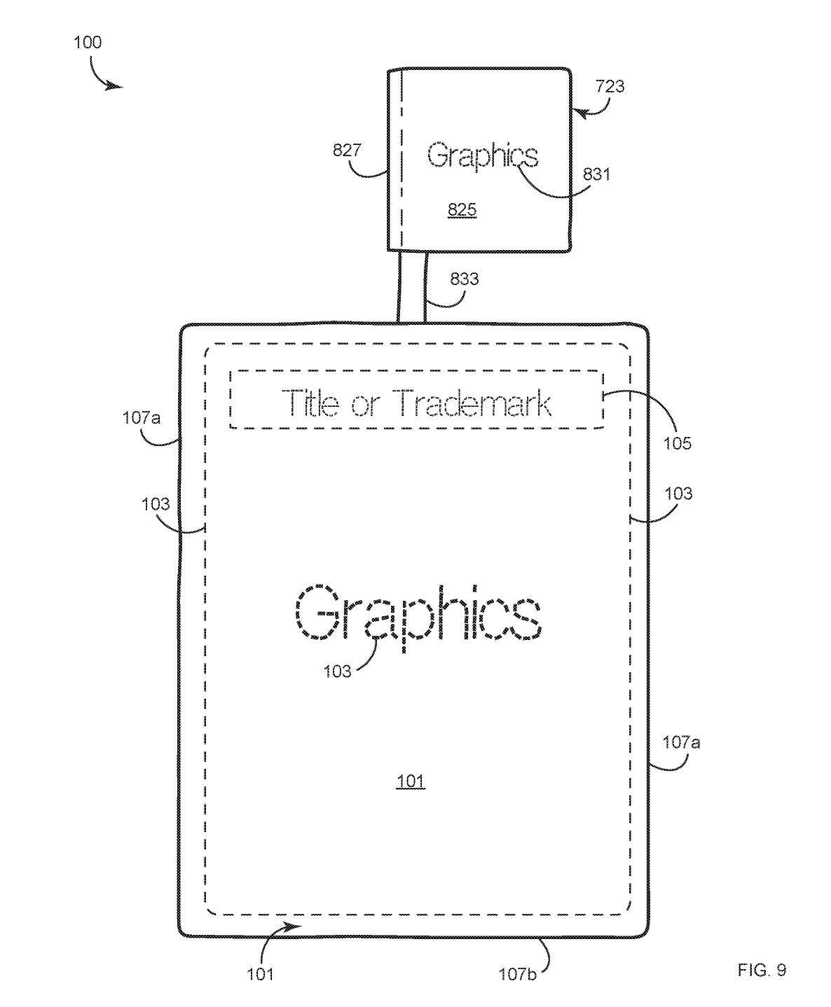

FIG. 8 may depict blanket 100, but from a different operational configuration as shown in FIG. 1 (and different from FIG. 7); wherein in FIG. 8, the removable soft-and-flexible-book 723 may be shown removed from at least one pocket 415, but still attached to blanket 100, shown from a top perspective view. Note FIG. 8 may also include a sectional-line 28-28 wherein a longitudinal-cross-sectional view from this sectional-line may be shown in FIG. 28. FIG. 9 may depict blanket 100 and the operational configuration shown in FIG. 8, wherein FIG. 9 may be shown from a top view.

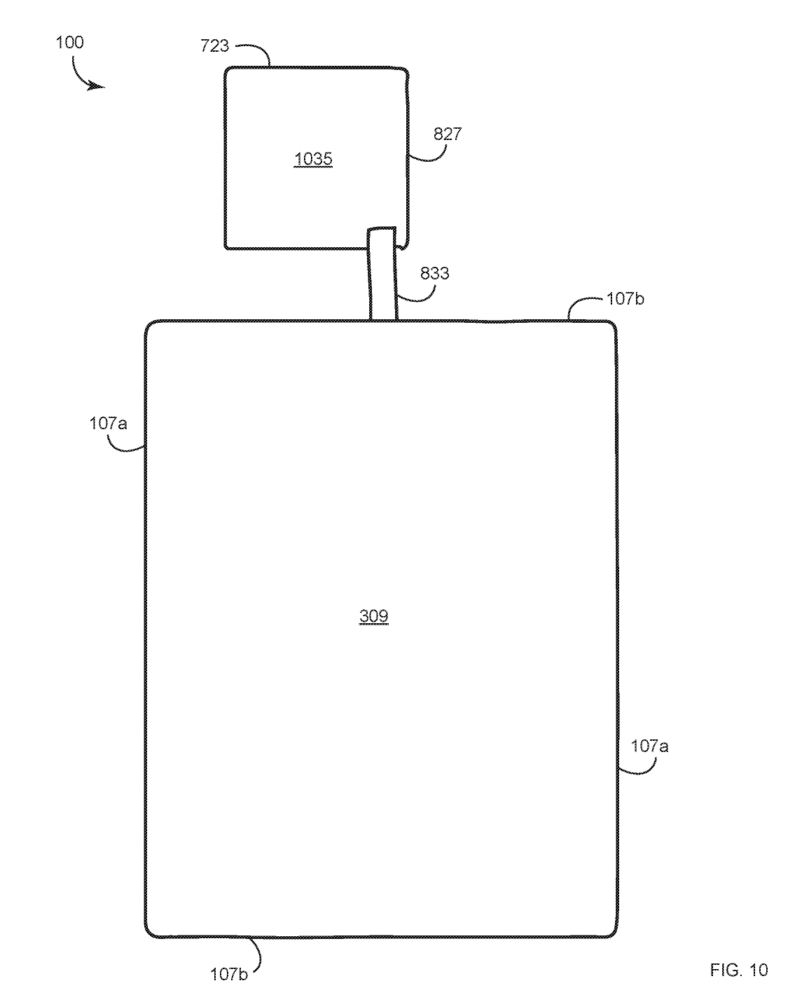

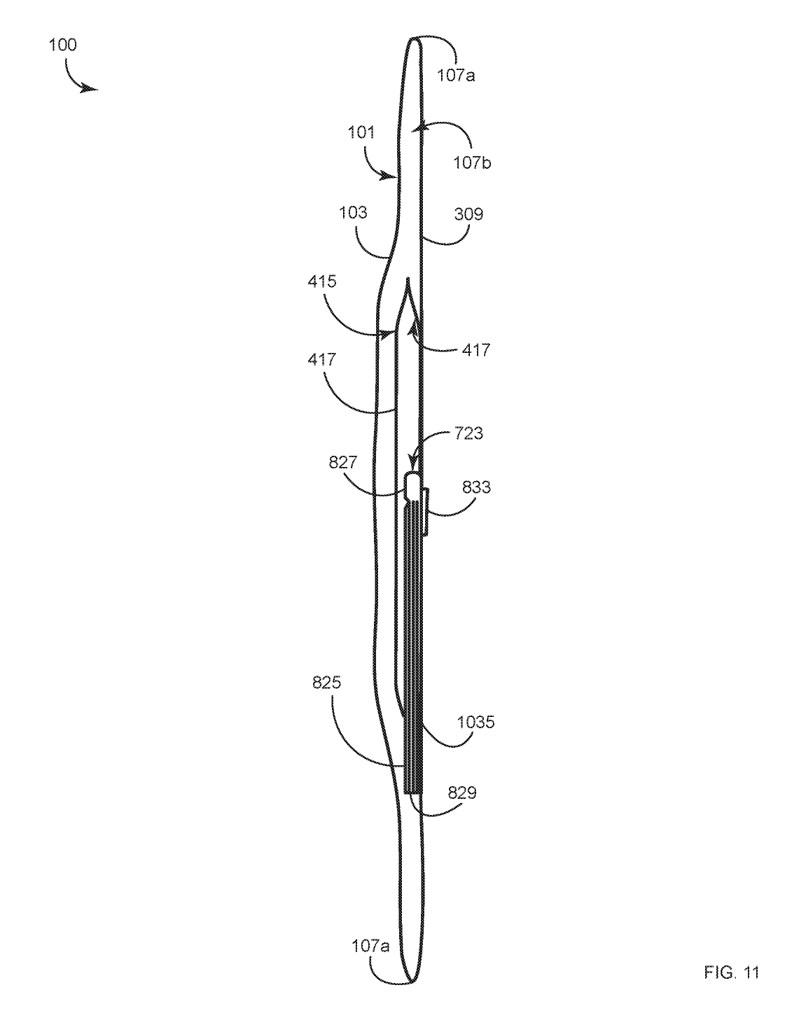

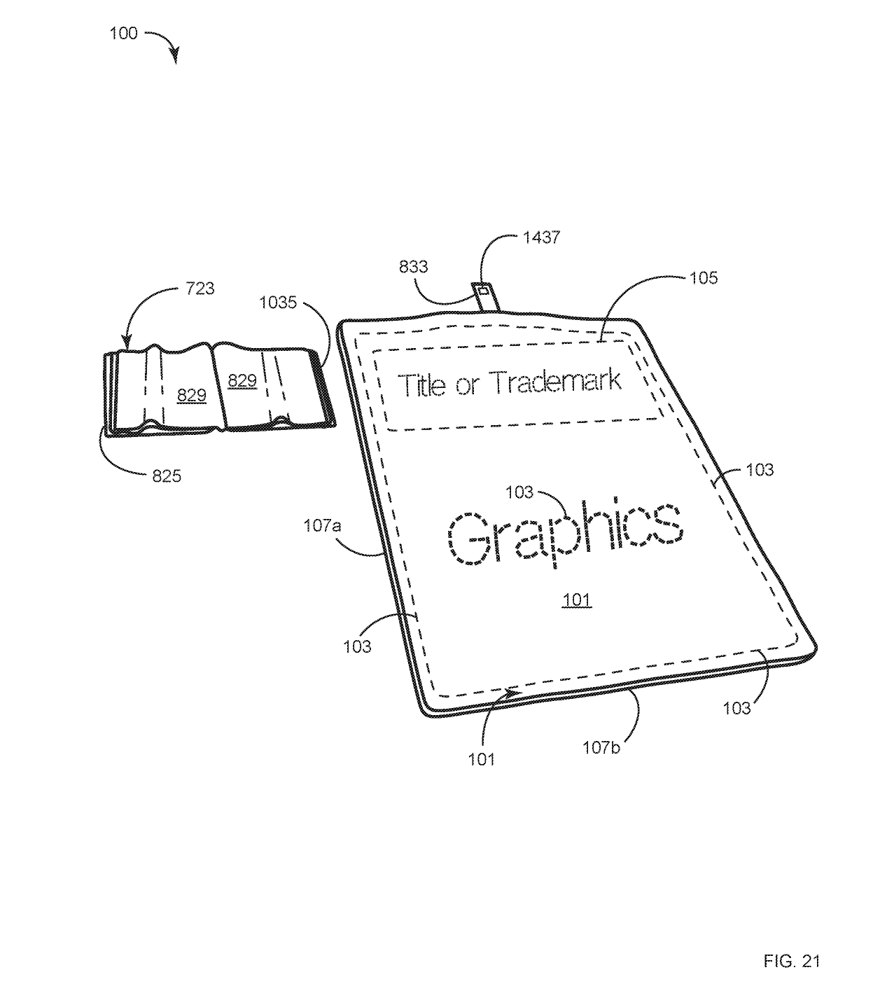

Discussing FIG. 8 and FIG. 9, in some embodiments, soft-and-flexible-book 723 may comprise a flexible-top-cover 825, flexible-bottom-cover 1035, one or more flexible-pages 829, and book-binding 827. In some embodiments, flexible-top-cover 825 and flexible-bottom-cover 1035 may function as a book cover to a book. In some embodiments, disposed within and between flexible-top-cover 825 and flexible-bottom-cover 1035 may be one or more flexible-pages 829. In some embodiments, one or more flexible-pages 829 may attach to book-binding 827 to form a spine of soft-and-flexible-book 723. See FIG. 8 and FIG. 9 for flexible-top-cover 825. See FIG. 8, FIG. 11, and FIG. 21 for examples of one or more flexible-pages 829. And see FIG. 10 for flexible-bottom-cover 1035. In some embodiments, one or more flexible-pages 829 may be attached within and between flexible-top-cover 825 and flexible-bottom-cover 1035 to form soft-and-flexible-book 723. In some embodiments, such page attachment may be from a seam, i.e., a fabric seam, such as a sewn seam. Depending upon the flexible and pliable materials of construction for soft-and-flexible-book 723, this seam that forms book-binding 827 (i.e., the spine of the book) may also be formed by one or more of: mechanical fasteners, chemical adhesives, solvent bonding, ultrasonic welding, and/or heat welding. In some embodiments, flexible-top-cover 825, flexible-bottom-cover 1035, and one or more flexible-pages 829 may each be comprised of one or more fabrics and/or textiles. In some embodiments, flexible-top-cover 825, flexible-bottom-cover 1035, and one or more flexible-pages 829 may each be substantially constructed from one or more fabrics and/or textiles. Such soft-and-flexible-book 723 fabrics and/or textiles may be the same or different from the fabrics and/or textiles substantially forming blanket 100. In some embodiments, flexible-top-cover 825, flexible-bottom-cover 1035, and one or more flexible-pages 829 may each be comprised of one or more types of flexible and pliable plastic sheets. In some embodiments, soft-and-flexible-book 723 may be rollable and/or foldable.

In some embodiments, flexible-top-cover 825, flexible-bottom-cover 1035, and one or more flexible-pages 829 may be all soft and substantially constructed from one or more fabrics.

Continuing discussing FIG. 8 and FIG. 9, in some embodiments, flexible-top-cover 825 may comprise graphics 831. In some embodiments, graphics 831 may be an external region on flexible-top-cover 825. In some embodiments, this graphics 831 may display one or more of: a graphic, a scene, a landscape, a logo, a trademark, an image, wording, a copy of a book cover, and/or the like. In some embodiments, graphics 831 may cover: substantially all of flexible-top-cover 825; a majority of flexible-top-cover 825; half of flexible-top-cover 825; or less than half of flexible-top-cover 825.

In some embodiments, soft-and-flexible-book 723 may have perimeter dimensions of about 18 inches by about 18 inches, when soft-and-flexible-book 723 may be closed and viewed from the top as in FIG. 9; wherein “about” in this context may be plus or minus one inch. However, in other embodiments, soft-and-flexible-book 723 may be other dimensions. In some embodiments, soft-and-flexible-book 723 may fit within at least one pocket 415 (e.g., within pocket-cavity 2843 shown in FIG. 28), without folding or rolling of soft-and-flexible-book 723.

Continuing discussing FIG. 8 and FIG. 9, in some embodiments, soft-and-flexible-book 723 may be removably attached to blanket 100. In some embodiments, soft-and-flexible-book 723 may be removably stored in at least one pocket 415; wherein at least one pocket 415 may be integral with blanket 100. See FIG. 4 and FIG. 28 for at least one pocket 415; see FIG. 6 for a possible location of pocket-region 621 in some embodiments; and see FIG. 28 for pocket-cavity 2843. Even when soft-and-flexible-book 723 may be in use, soft-and-flexible-book 723 may still be removably attached to blanket 100, e.g., via tether 833.

Continuing discussing FIG. 8 and FIG. 9, in some embodiments, blanket 100 may comprise tether 833. In some embodiments, at least one pocket 415 may comprise tether 833. In some embodiments, soft-and-flexible-book 723 may comprise tether 833. In some embodiments, tether 833 may be in communication with at least one pocket 415 and in communication with soft-and-flexible-book 723. In some embodiments, tether 833 may be an elongate member. In some embodiments, tether 833 may be strip of material. In some embodiments, tether 833 may be strip of strapping material. In some embodiments, tether 833 may be elastic. In some embodiments, tether 833 may be substantially comprised of one or more fabrics and/or textiles. In some embodiments, tether 833 may comprise a pair of opposing terminal-ends 2845. See e.g., FIG. 28 for the opposing terminal-end 2845 which may be removably attached to flexible-bottom-cover 1035 of soft-and-flexible-book 723.

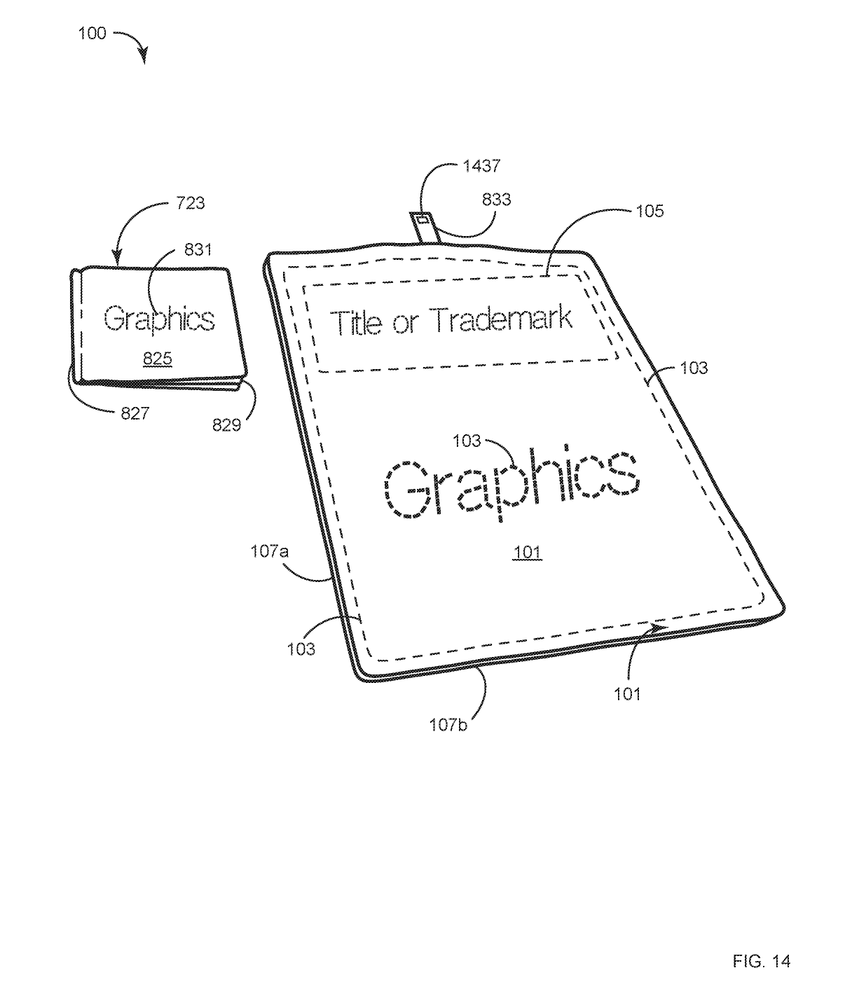

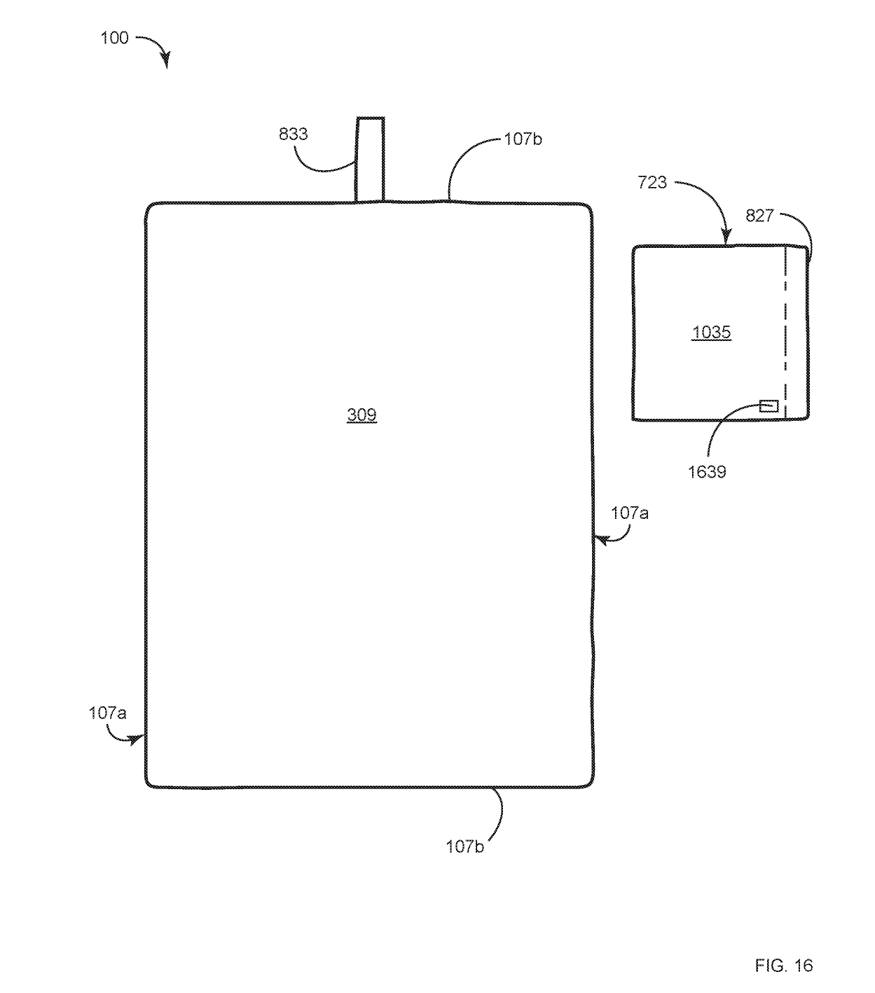

In some embodiments, a nature of the communication between tether 833 and at least one pocket 415 may be attachment of one of the terminal-ends 2845 to pocket-cavity 2843 (see e.g., FIG. 28). In some embodiments, a nature of the communication between tether 833 and soft-and-flexible-book 723 may be by fastener-on-tether 1437 (see FIG. 14) that may be removably attached to fastener-on-book 1639 (see FIG. 16).

In some embodiments, one terminal-end 2845 of tether 833 may be attached to pocket-cavity 2843; and the other terminal-end 2845 may comprise fastener-on-tether 1437 (see FIG. 14) which may removably attach to fastener-on-book 1639 (see FIG. 16).

In some embodiments, one terminal-end 2845 of tether 833 may be removably attached to pocket-cavity 2843 via removable mechanical fastener hardware; and the other terminal-end 2845 may comprise fastener-on-tether 1437 (see FIG. 14) which may removably attach to fastener-on-book 1639 (see FIG. 16). In some embodiments, each opposing terminal-end 2845 may comprise removable mechanical fastener hardware (e.g., fastener-on-tether 1437).

In some embodiments, fastener-on-tether 1437 may comprise may comprise one or more types of mechanical fasteners, such as, but not limited to: zippers, Velcro (i.e., plurality of hooks with complimentary plurality of loops), snap closures, buttons, tie strings, and/or the like. In some embodiments, fastener-on-book 1639 may comprise may comprise one or more types of mechanical fasteners, such as, but not limited to: zippers, Velcro (i.e., plurality of hooks with complimentary plurality of loops), snap closures, buttons, tie strings, and/or the like. In some embodiments, fastener-on-tether 1437 and fastener-on-book 1639 may be complimentary to each other, for removable attachment to each other.

In some embodiments, the opposing terminal-end 2845 of tether 833 attached to pocket-cavity 2843 may be a non-removable attachment, i.e., a permanent attachment. See e.g., FIG. 28.

In some embodiments, the opposing terminal-end 2845 of tether 833 attached to flexible-bottom-cover 1035 may be a non-removable attachment, i.e., a permanent attachment. In such embodiments, such permanent attachments may be via sown stitching, other mechanical fasteners, and where the materials of construction permit, by chemical adhesive, solvent bonding, ultrasonic bonding, and/or heat welding.

FIG. 10 may depict blanket 100 and the operational configuration shown in FIG. 8, wherein FIG. 10 may be shown from a bottom view. FIG. 10 may be an opposing view to FIG. 9. FIG. 10 may be a first figure depicting flexible-bottom-cover 1035 to soft-and-flexible-book 723. FIG. 10 may also show a portion of tether 833 extending (emerging) from the at least one pocket 415, wherein a terminal portion of tether 833 may be (removably, in some embodiments) attached to flexible-bottom-cover 1035.

FIG. 11 may depict blanket 100 and the operational configuration shown in FIG. 8, wherein FIG. 11 may be shown from a front view (i.e., a pocket access view). In FIG. 11 portions of soft-and-flexible-book 723 may be shown, such as, flexible-top-cover 825, book-binding 827, flexible-pages 829, and flexible-bottom-cover 1035 may be visible.

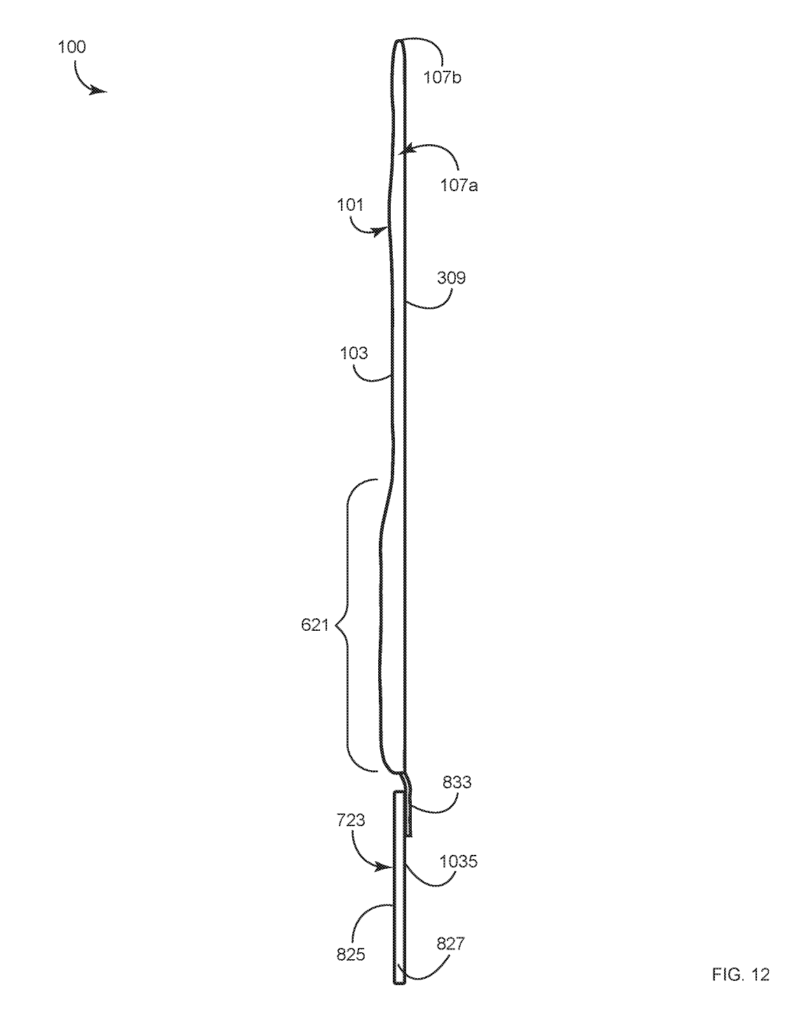

FIG. 12 may depict blanket 100 and the operational configuration shown in FIG. 8, wherein FIG. 12 may be shown from a left-side view. FIG. 12 may show pocket-region 621. In FIG. 12 portions of soft-and-flexible-book 723 may be shown, such as, flexible-top-cover 825, book-binding 827, and flexible-bottom-cover 1035 may be visible.

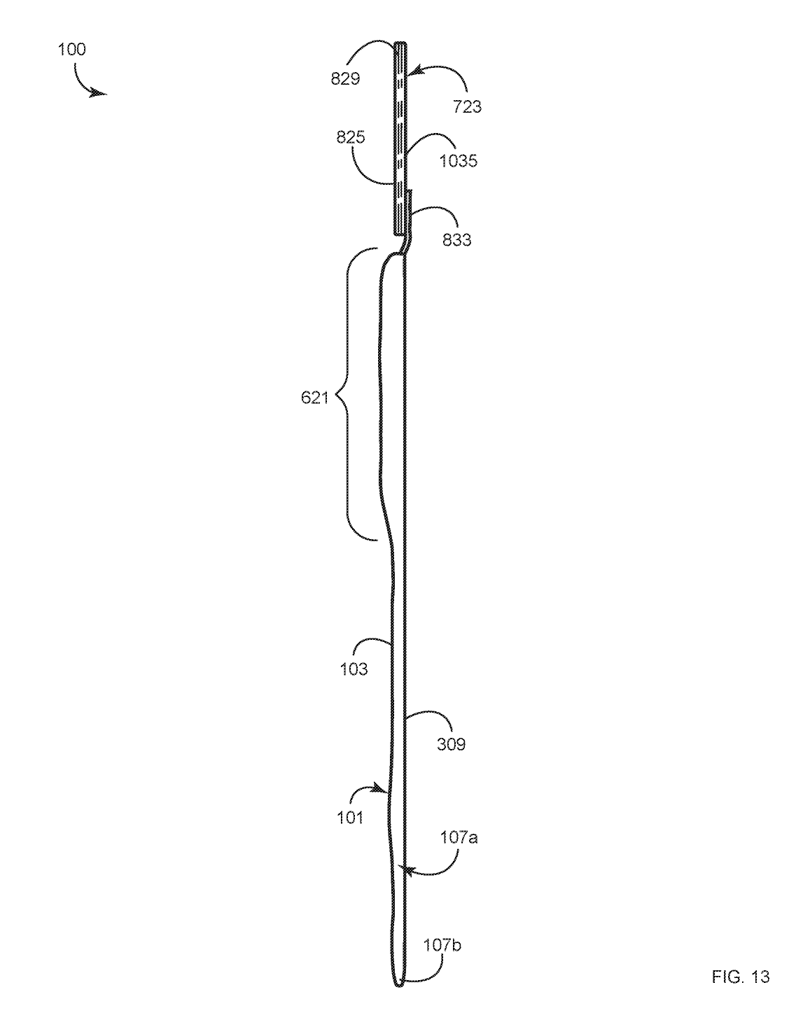

FIG. 13 may depict blanket 100 and the operational configuration shown in FIG. 8, wherein FIG. 12 may be shown from a right-side view. FIG. 13 may be an opposing view to FIG. 12. FIG. 13 may show pocket-region 621. In FIG. 11 portions of soft-and-flexible-book 723 may be shown, such as, flexible-top-cover 825, flexible-pages 829, and flexible-bottom-cover 1035 may be visible.

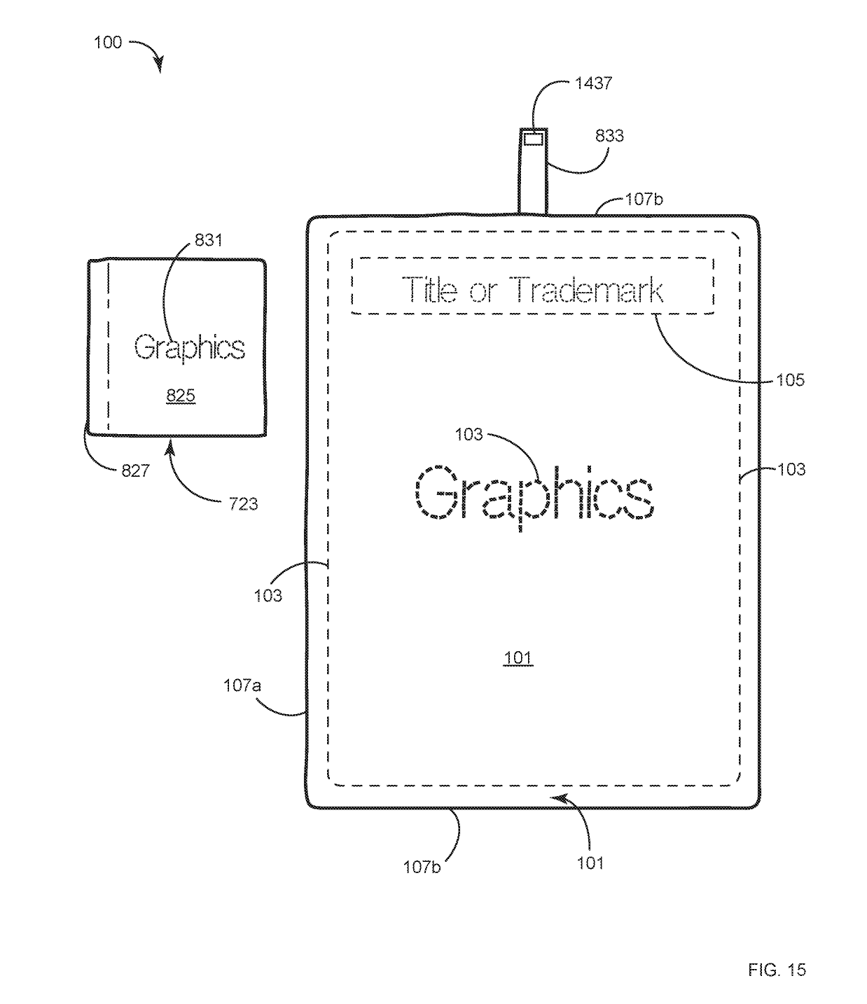

FIG. 14 may depict blanket 100, but from a different operational configuration as shown in FIG. 1 and different from FIG. 7 and different from FIG. 8; wherein in FIG. 14, the removable soft-and-flexible-book 723 may be shown removed from the at least one pocket 415, and removably detached from blanket 100 (i.e., removably detached from tether 833), shown from a top perspective view. FIG. 15 may depict blanket 100 and the operational configuration shown in FIG. 14, wherein FIG. 15 may be shown from a top view.

In FIG. 14 and in FIG. 15, with soft-and-flexible-book 723 removably detached from tether 833, fastener-on-tether 1437 may be visible. In some embodiments, tether 833 may comprise fastener-on-tether 1437. In some embodiments, fastener-on-tether 1437 may be located on tether 833. In some embodiments, fastener-on-tether 1437 may be located at a terminal-end 2845 (see FIG. 28) of tether 833. In some embodiments, fastener-on-tether 1437 may be located proximate (e.g., three inches or less) to terminal-end 2845 of tether 833. In some embodiments, fastener-on-tether 1437 may removably attach to fastener-on-book 1639, which may be located on flexible-bottom-cover 1035 of soft-and-flexible-book 723. In some embodiments, fastener-on-tether 1437 may comprise may comprise one or more types of mechanical fasteners, such as, but not limited to: zippers, Velcro (i.e., plurality of hooks with complimentary plurality of loops), snap closures, buttons, tie strings, and/or the like.

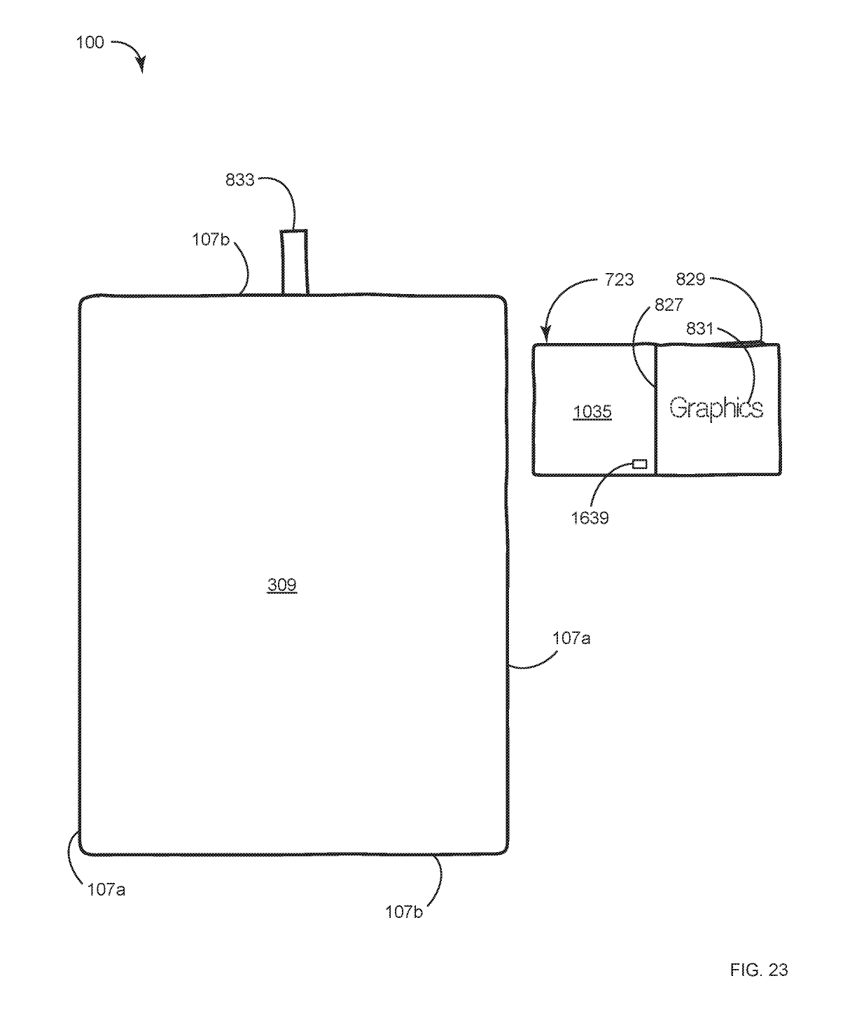

FIG. 16 may depict blanket 100 and the operational configuration shown in FIG. 14, wherein FIG. 16 may be shown from a bottom view. FIG. 16 may be an opposing view to FIG. 15. FIG. 16 (and FIG. 23) may show fastener-on-book 1639. In some embodiments, flexible-bottom-cover 1035 may comprise fastener-on-book 1639. In some embodiments, fastener-on-book 1639 may be located on flexible-bottom-cover 1035. In some embodiments, fastener-on-book 1639 may be located on book-binding 827. In some embodiments, fastener-on-book 1639 may removably attach to fastener-on-tether 1437. In some embodiments, fastener-on-book 1639 may comprise may comprise one or more types of mechanical fasteners, such as, but not limited to: zippers, Velcro (i.e., plurality of hooks with complimentary plurality of loops), snap closures, buttons, tie strings, and/or the like.

In some embodiments, fastener-on-book 1639 and fastener-on-tether 1437 may be complimentary mechanical fasteners selected from one or more of: buttons; Velcro (e.g., plurality of hooks and complimentary plurality of loops to removably attach to the plurality of hooks); zippers; ties; snap buttons; press buttons; zip-locks; press-fits; and/or the like.

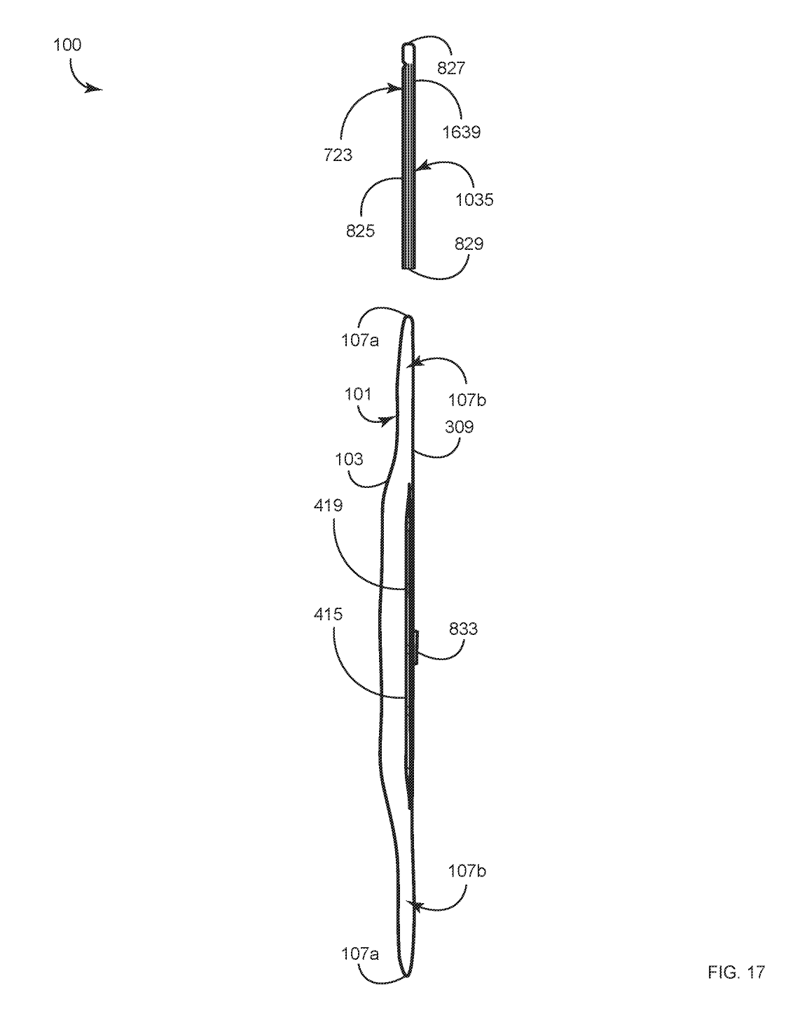

FIG. 17 may depict blanket 100 and the operational configuration shown in FIG. 14, wherein FIG. 17 may be shown from a front view (i.e., the pocket access view).

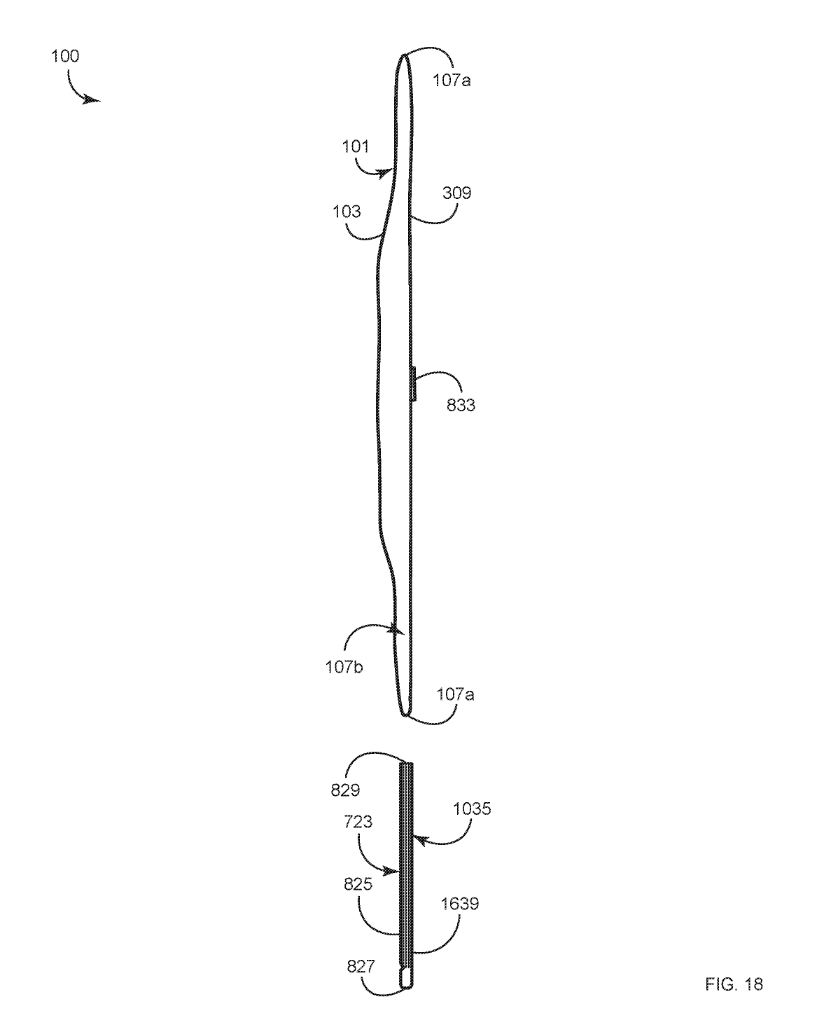

FIG. 18 may depict blanket 100 and the operational configuration shown in FIG. 14, wherein FIG. 18 may be shown from a back view. FIG. 18 may be an opposing view to FIG. 17.

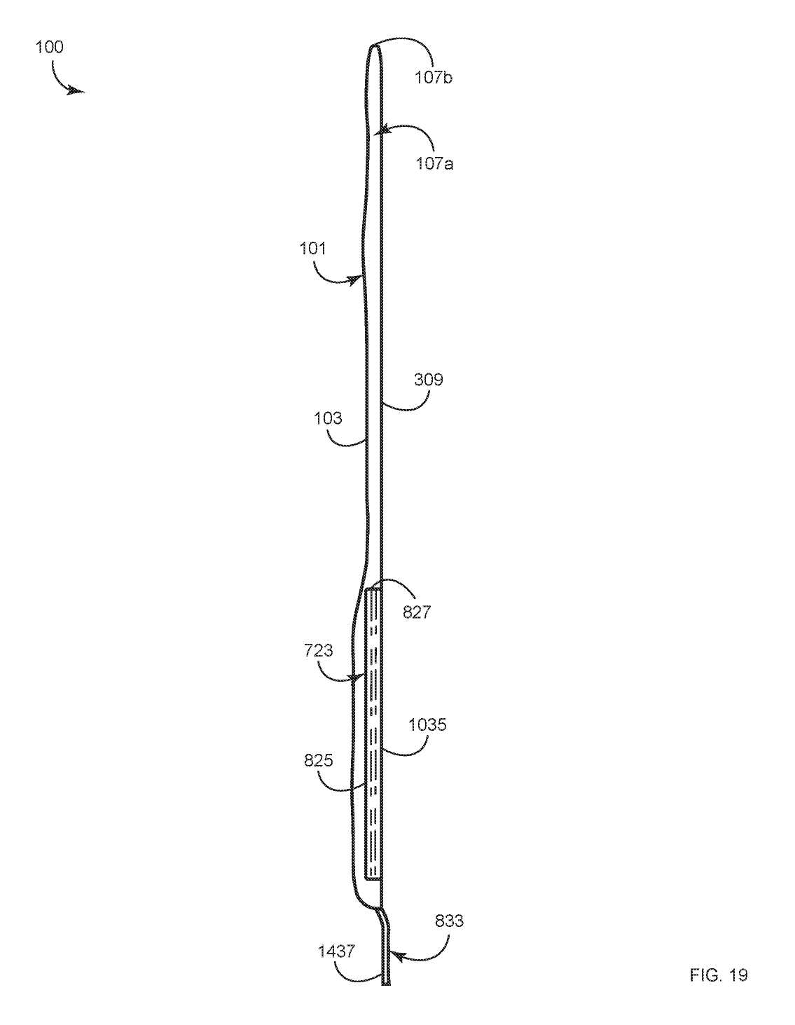

FIG. 19 may depict blanket 100 and the operational configuration shown in FIG. 14, wherein FIG. 19 may be shown from a left-side view.

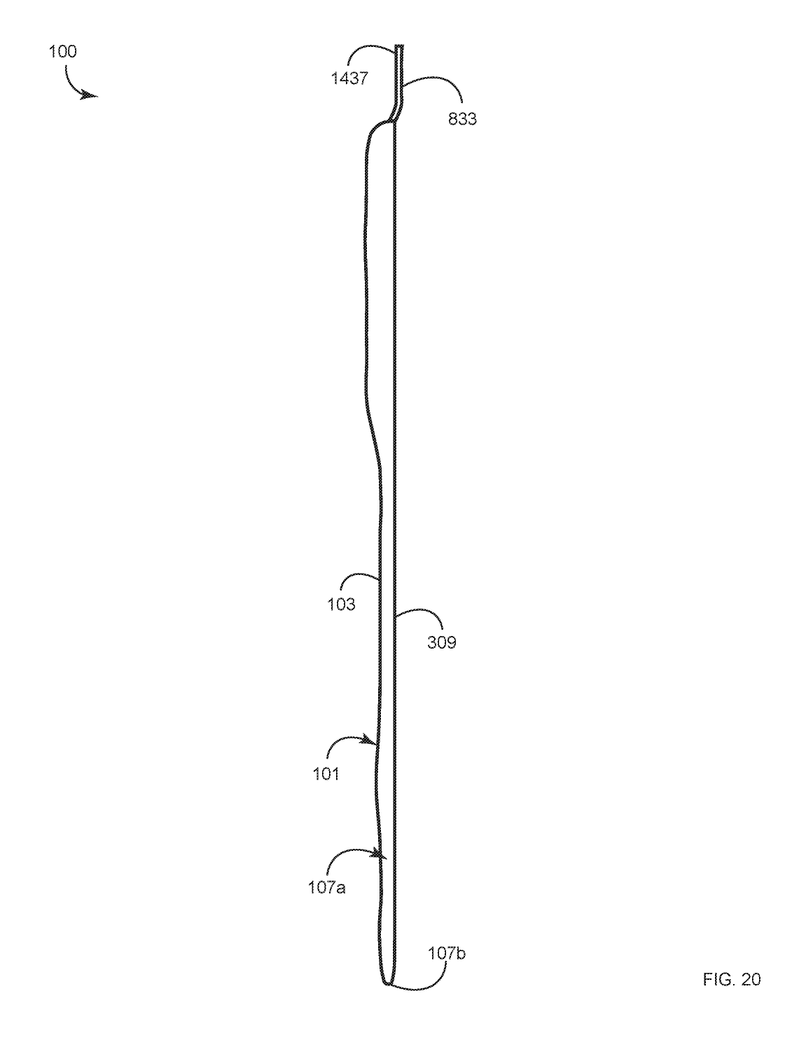

FIG. 20 may depict blanket 100 and the operational configuration shown in FIG. 14, wherein FIG. 20 may be shown from a right-side view. FIG. 20 may be an opposing view to FIG. 19.

FIG. 21 may depict blanket 100, but from a different operational configuration as shown in FIG. 1 and different from FIG. 7 and different from FIG. 8 and different from FIG. 14; wherein in FIG. 21, the removable soft-and-flexible-book 723 may be shown removed from the at least one pocket 415, removably detached from blanket 100 (i.e., removably detached from tether 833), and soft-and-flexible-book 723 may be shown in an open configuration, with FIG. 21 shown from a top perspective view. In FIG. 21, a soft, flexible, and pliable nature of flexible-pages 829 (of soft-and-flexible-book 723) may be evident. In some embodiments, flexible-pages 829 may be substantially constructed from soft, flexible, and pliable fabrics and/or textiles.

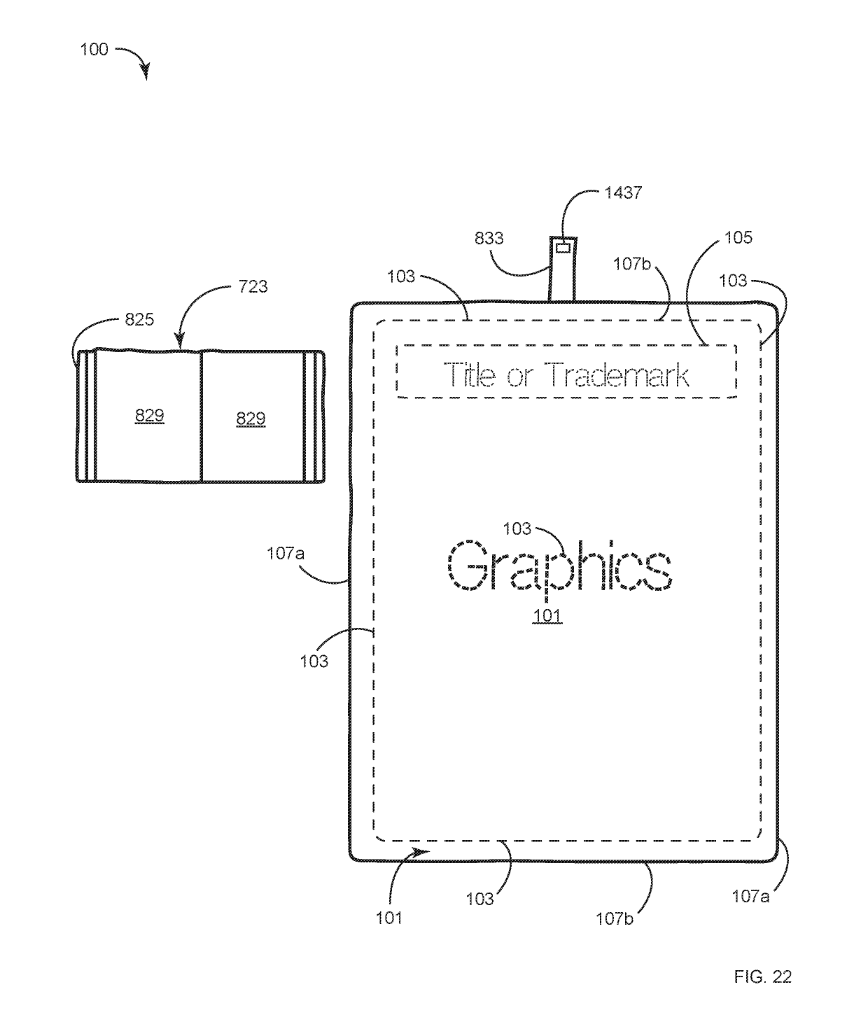

FIG. 22 may depict blanket 100 and the operational configuration shown in FIG. 21, wherein FIG. 22 may be shown from a top view. Fastener-on-tether 1437 may be shown in FIG. 21 and in FIG. 22.

FIG. 23 may depict blanket 100 and the operational configuration shown in FIG. 21, wherein FIG. 23 may be shown from a bottom view. FIG. 23 may be an opposing view to FIG. 22. Fastener-on-book 1639 may be shown in FIG. 23.

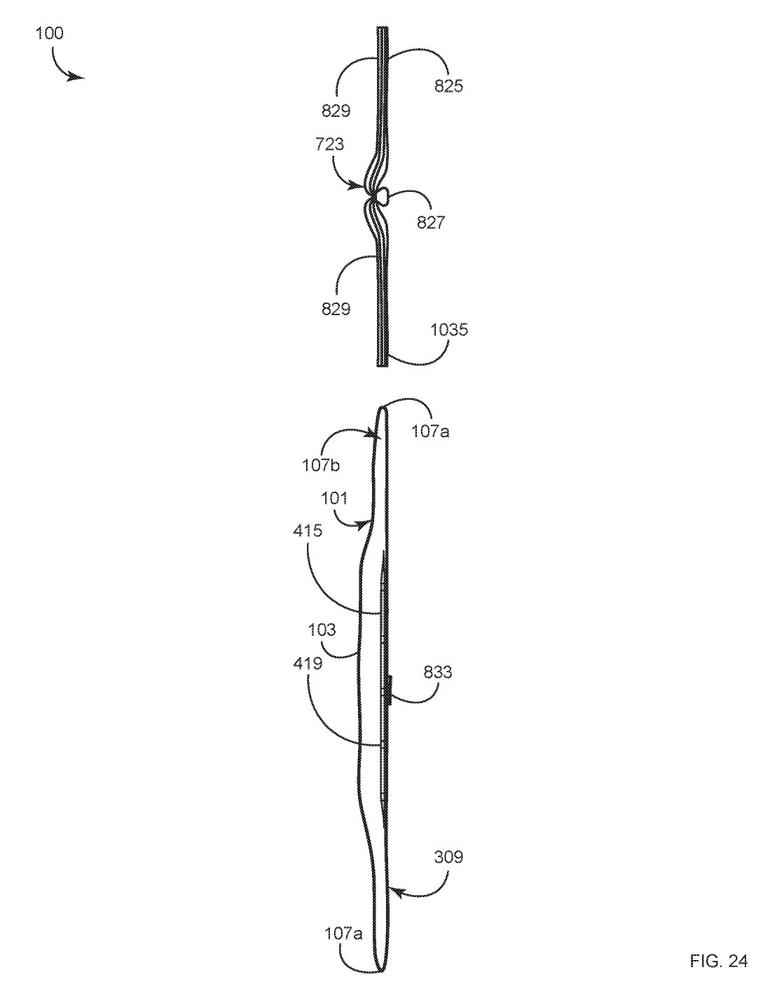

FIG. 24 may depict blanket 100 and the operational configuration shown in FIG. 21, wherein FIG. 24 may be shown from a front view (i.e., the pocket access view).

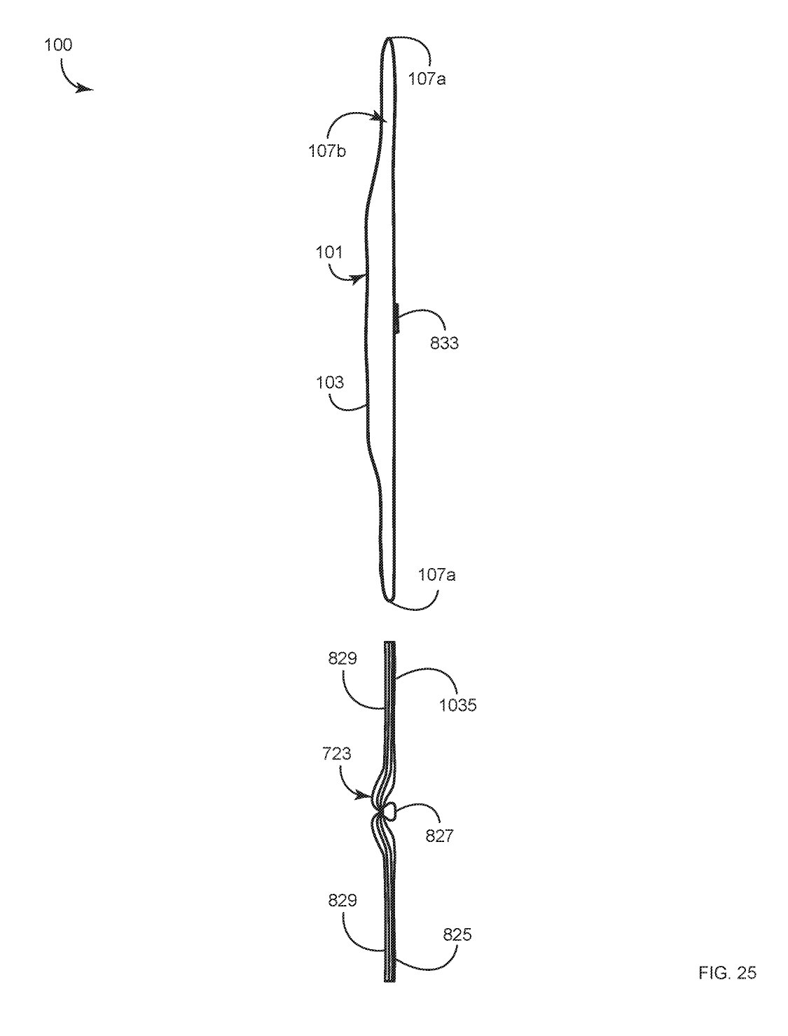

FIG. 25 may depict blanket 100 and the operational configuration shown in FIG. 21, wherein FIG. 25 may be shown from a back view. FIG. 25 may be an opposing view to FIG. 24. In FIG. 24 and in FIG. 25, a soft, flexible, and pliable nature of flexible-pages 829 (of soft-and-flexible-book 723) may be evident. In some embodiments, flexible-pages 829 may be substantially constructed from soft, flexible, and pliable fabrics and/or textiles.

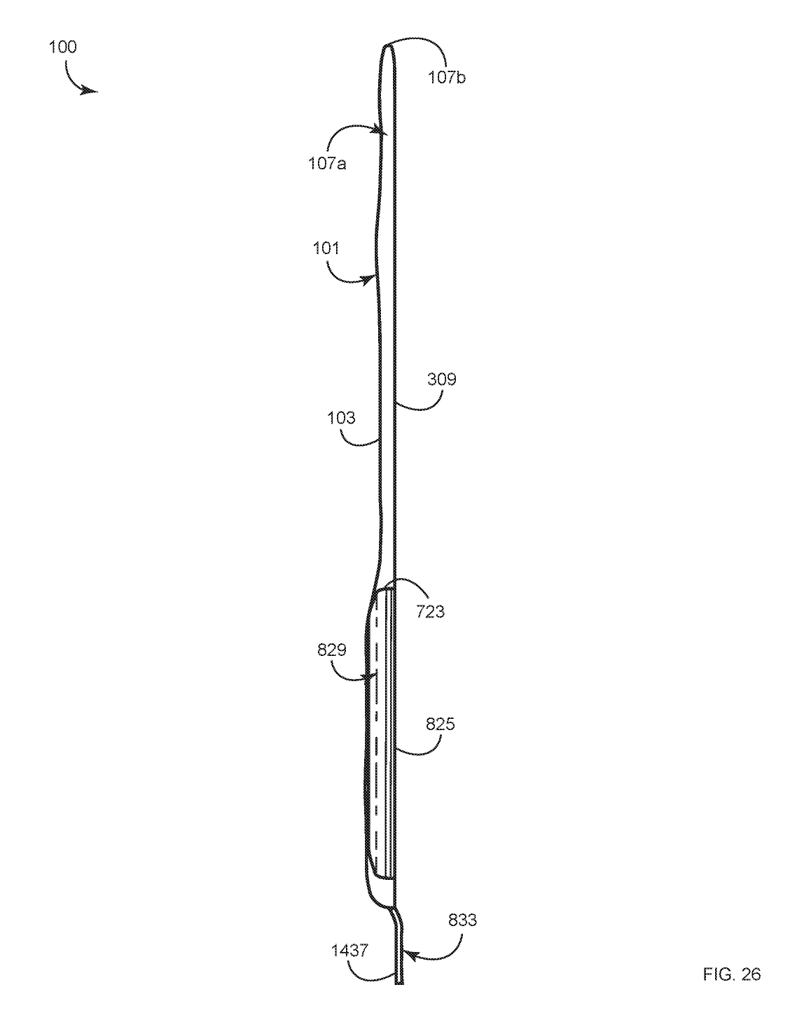

FIG. 26 may depict blanket 100 and the operational configuration shown in FIG. 21, wherein FIG. 26 may be shown from a left-side view.

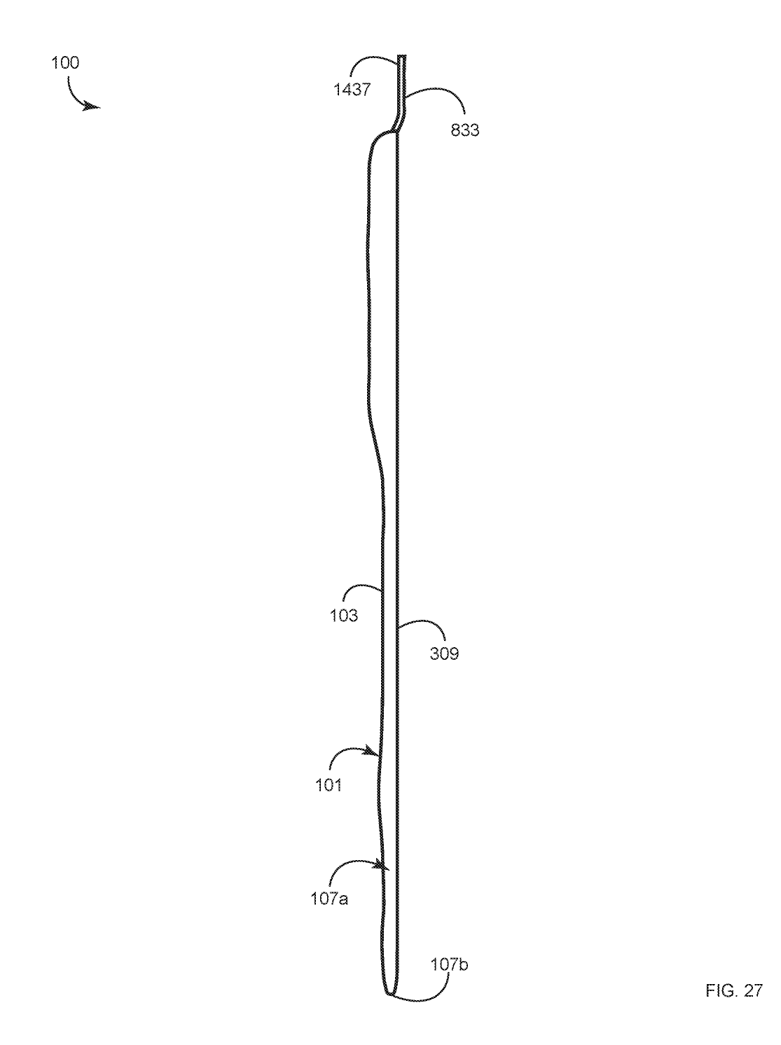

FIG. 27 may depict blanket 100 and the operational configuration shown in FIG. 21, wherein FIG. 27 may be shown from a right-side view. FIG. 27 may be an opposing view to FIG. 26.

FIG. 28 may depict a longitudinal-cross-section of blanket 100 along sectional-line 28-28 that was shown in FIG. 8. FIG. 28 may show blanket-interior 2841 of blanket 100. In some embodiments, blanket 100 may comprise blanket-interior 2841. In some embodiments, blanket-interior 2841 may be substantially bound by top-exterior-layer 101, bottom-exterior-layer 309, and edges 107. In some embodiments, blanket-interior 2841 may be a combination of ply from top-exterior-layer 101 and of ply from bottom-exterior-layer 309. In some embodiments, blanket-interior 2841 may comprise a filling material, i.e., a filler. In some embodiments, this filler may be selected from one or more of: down, batting, stuffing, foam, pellets, beads, and/or the like.

FIG. 28 may show a longitudinal cross-section through the at least one pocket 415; which may then reveal portions of pocket-cavity 2843. In some embodiments, the at least one pocket 415 may substantially bound a volume for removably housing soft-and-flexible-book 723. This volume may be defined by pocket-cavity 2843. FIG. 18 may also show a portion of the at least one pocket-opening 417 which may provide access to pocket-cavity 2843.

In some embodiments, blanket 100 may comprise at least one pocket 415; wherein the at least one pocket 415 may comprise pocket-cavity 2843 that may be sized to removably house soft-and-flexible-book 723; wherein the at least one pocket 415 may comprise at least one pocket-opening 417 for providing access to pocket-cavity 2843. See e.g., FIG. 28.

In some embodiments, the least one pocket 415 may comprise pocket-sealer 419 at the at least one pocket-opening 417 for removably sealing the at least one pocket-opening 417. See e.g., FIG. 28. In some embodiments, pocket-sealer 419 may be mechanical fasteners. In some embodiments, such mechanical fasteners may be selected from one or more of: buttons; Velcro (e.g., plurality of hooks and complimentary plurality of loops to removably attach to the plurality of hooks); zippers; ties; snap buttons; press buttons; zip-locks; press-fits; and/or the like.

In some embodiments, a length of the pocket-cavity 2843 that extends substantially parallel with a length (e.g., length 311) of blanket 100 may extend according to a ratio selected from a range of 0.10 to 0.40; wherein this ratio is with respect to the length of the pocket-cavity 2843 to the length (e.g., length 311) of blanket 100. In other embodiments, this range may be: 0.20 to 0.24; 0.15 to 0.25; or 0.20 to 0.33.

In some embodiments, the at least one pocket 415 may be disposed between top-exterior-layer 101 and bottom-exterior-layer 309 with the at least one pocket-opening 417 located at a portion of edge 107 (e.g., short-edge 107b).

FIG. 28 may show the two opposing terminal-ends 2845 of tether 833. As shown in FIG. 28, one such terminal-end 2845 may be attached to a portion/region of pocket-cavity 2843. In some embodiments, a nature of such attachment may be permanent; whereas, in other embodiments, this attachment may be removable. The other terminal-end 2845 (shown extending from pocket-cavity 2843) may be removably attached to soft-and-flexible-book 723 (via removable connection between fastener-on-tether 1437 and fastener-on-book 1639). In some embodiments, tether 833 may be an elongate member that may be substantially planar and longer than wide; and tether 833 may be flexible.

Also, note in some embodiments, at least one pocket 415 may be about 22 inches by about 22 inches; wherein “about’ may be plus or minus one inch. That is, in some embodiments, a length by a width dimension of at least one pocket 415 may be about 22 inches by about 22 inches; wherein “about’ may be plus or minus one inch. Also, not in some embodiments, tether 833 may be about three inches wide by about ten inches long; wherein “about” may be plus or minus two inches. Also note, in other embodiments, at least one pocket 415 and/or tether 833 may be other dimensions.

In some embodiments, blanket 100 may comprise at least one pocket 415 for receiving soft-and-flexible-book 723. In some embodiments, soft-and-flexible-book 723, without folding and/or rolling may fit entirely within at least one pocket 415. In some embodiments, a length and a width of at least one pocket 415 may be larger than a depth of at least one pocket 415. In some embodiments, at least one pocket 415 may be substantially constructed from one or more fabrics and/or textiles. Such fabrics and/or textiles may be the same or may be different from the fabrics and/or textiles comprising blanket 100 surfaces and/or layers (e.g., top-exterior-layer 101 and bottom-exterior-layer 309). In some embodiments, at least one pocket 415 may be disposed between top-exterior-layer 101 and bottom-exterior-layer 309. See e.g., FIG. 28.

In single ply (single layer) embodiment of blanket 100, at least one pocket 415 may be attached to one of the two opposing surfaces of blanket 100. In some multi-ply embodiments of blanket 100, at least one blanket 415 may be attached to one of the two opposing surfaces of blanket 100. In some multi-ply embodiments of blanket 100, at least one blanket 415 may be disposed between two opposing surfaces of blanket 100, such as between top-exterior-layer 101 and bottom-exterior-layer 309.

In some embodiments, at least one pocket 415 may comprise at least one opening 417 for accessing at least one pocket 415. In some embodiments, at least one opening 417 may be located at or proximate to edge 107b of blanket 100. In some embodiments, this proximate distance between at least one opening 417 and a given edge 107b may be within 36 inches. This given edge 107b may be edge 107b that is closest to at least one opening 417. In some embodiments, at least one opening 417 may be removably sealable by pocket-sealer 419. In some embodiments, disposed at or proximate to at least one opening 417 may be pocket-sealer 419. In some embodiments, pocket-sealer 419 may comprise one or more types of mechanical fasteners, such as, but not limited to; zippers, Velcro (i.e., plurality of hooks with complimentary plurality of loops), snap closures, buttons, tie strings, and/or the like. Additionally, in some embodiments, pocket-sealer 419 may be substantially continuous along at least one opening 417. Whereas, in other embodiments, location of pocket-sealer 419 along at least one opening 417 may be intermittent or with at least one paired opposing region for removable closure. See e.g., FIG. 7.

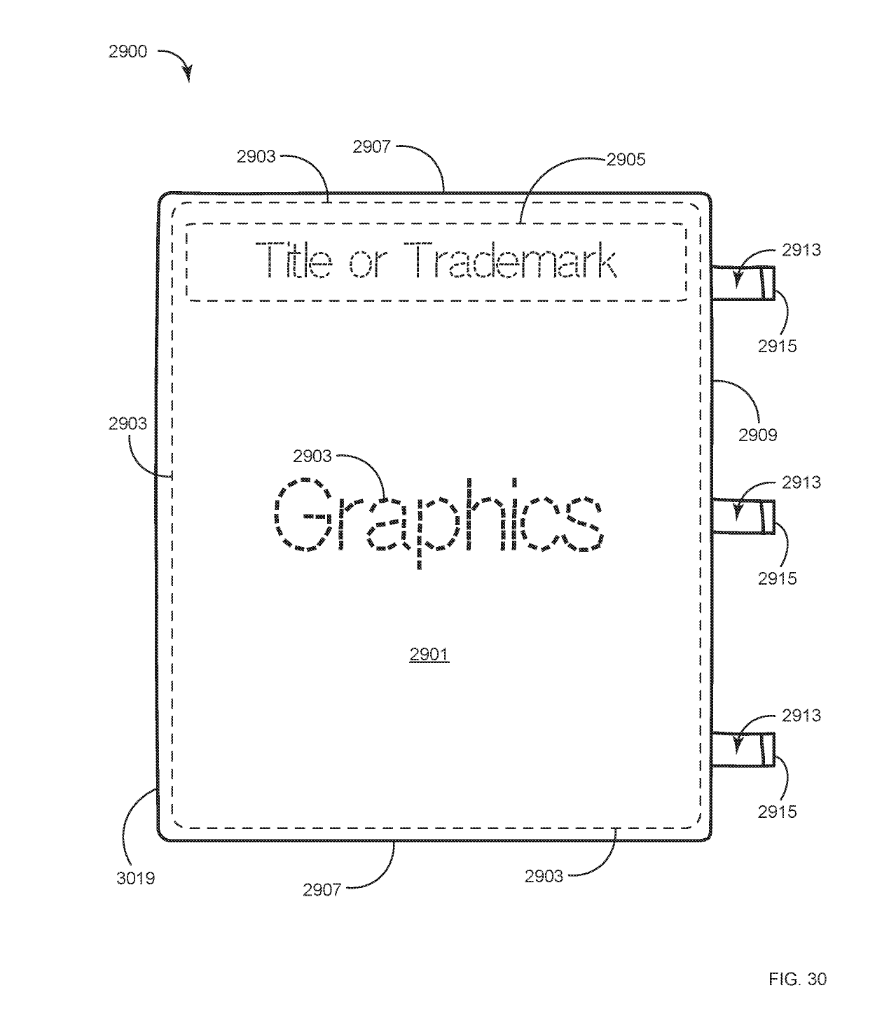

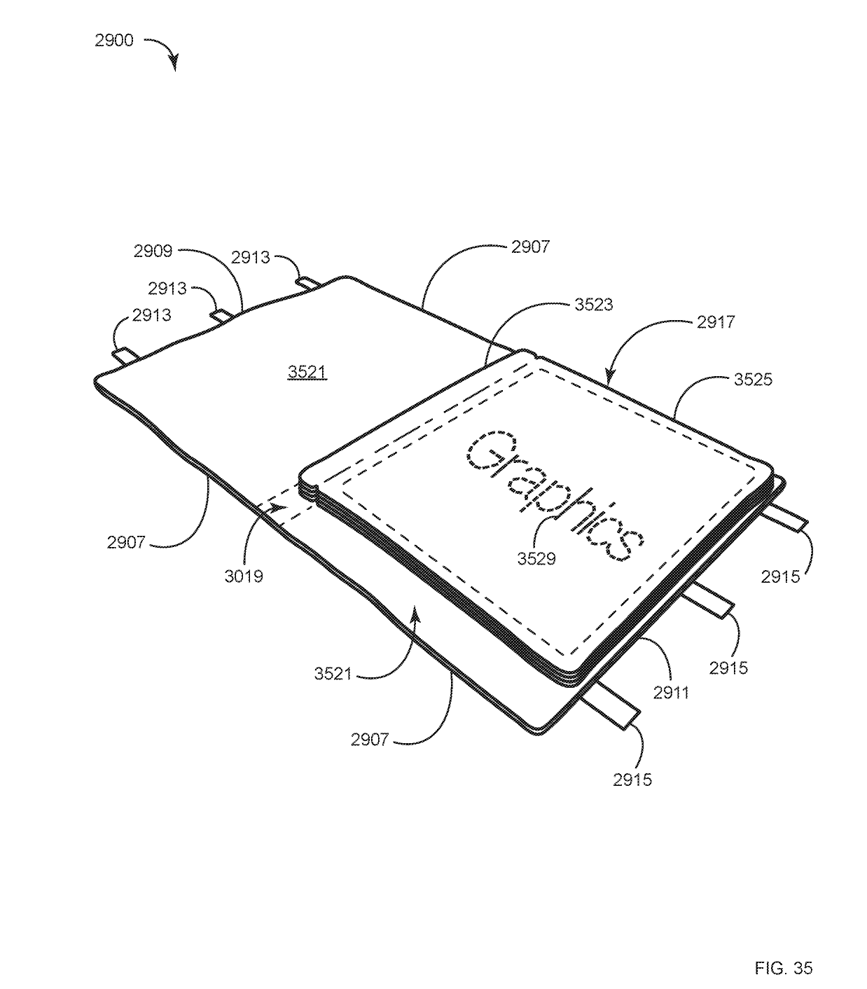

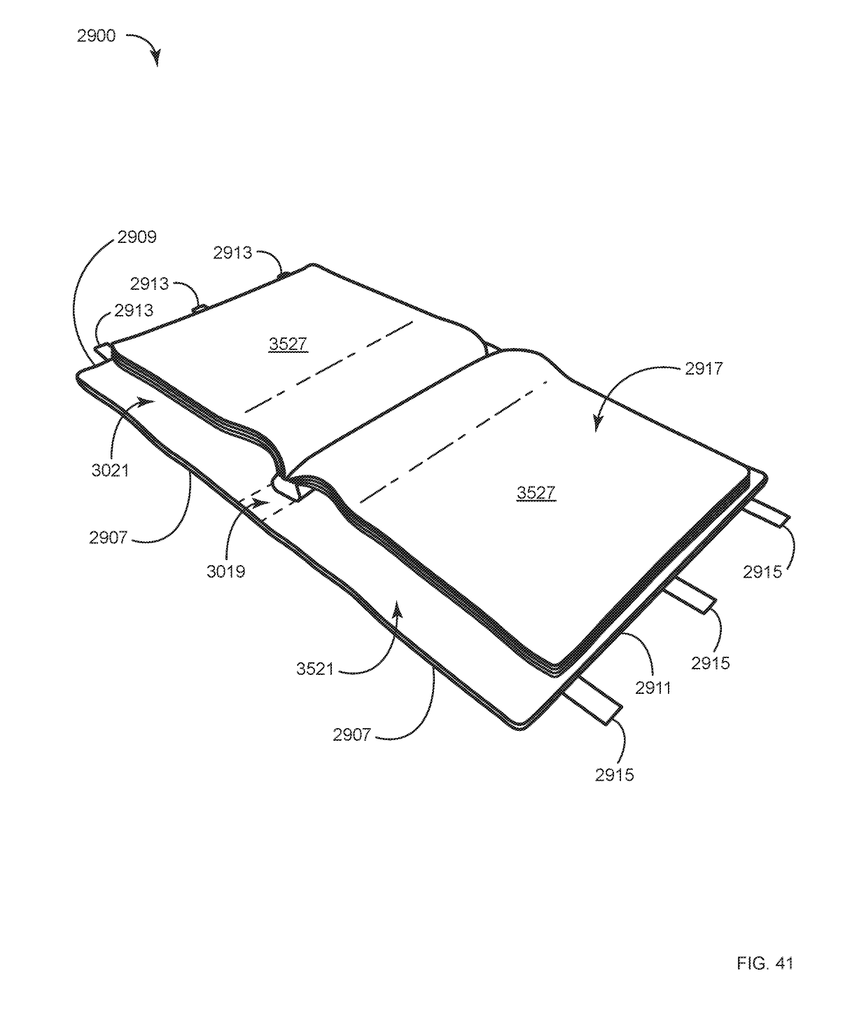

In some embodiments, FIG. 29 through FIG. 48 may depict an entertainment system (different from the entertainment system of FIG. 1 through FIG. 28). In some embodiments, this entertainment system may comprise a blanket 2900 with a removable soft-and-flexible-book 2917, wherein soft-and-flexible-book 2917 may be removably attached to blanket 2900. In some embodiments, this entertainment system may exist in three main operational configurations, the blanket configuration or the closed blanket configuration or the folded blanket configuration (see e.g., FIG. 29 through FIG. 34); the unfolded blanket configuration, but where the book (soft-and-flexible-book 2917) may be closed (see e.g., FIG. 35 through FIG. 40); or the active reading configuration, wherein the blanket may be unfolded and the book (soft-and-flexible-book 2917) may be open (see e.g., FIG. 41 through FIG. 45). In some embodiments, blanket 2900 may exist in the one of two operational configurations, the folded blanket configuration or the unfolded blanket configuration. In the folded blanket configuration, blanket 2900 may be folded in half, such that two different regions of inside-exterior-surface 3521 (see FIG. 35) may be formed that face each other. Each of these two different regions of inside-exterior-surface 3521 may be about half of the entire inside-exterior-surface 3521. Such a fold may be at folded-edge 3019 (see FIG. 30). While blanket 2900 may be in folded blanket configuration, blanket 2900 may resemble a folder, wherein such a folder may removably house flexible soft-and-flexible-book 2917. In some embodiments, when this entertainment system may be in the folded blanket configuration, flexible soft-and-flexible-book 2917 may be removably disposed between the two different regions of inside-exterior-surface 3521, i.e., within the folder. See e.g., FIG. 29. In some embodiments, when blanket 2900 may be in the folded blanket configuration, soft-and-flexible-book 2917 may be removably disposed between the two different regions of inside-exterior-surface 3521. That is, blanket 2900 in FIG. 29 may be removably housing flexible soft-and-flexible-book 2917 within this folder structure which may be formed from blanket 2900 folding in half over itself, i.e., between the two different regions of inside-exterior-surface 3521. And note, when blanket 2900 may be in the folded blanket configuration, flexible soft-and-flexible-book 2917 and these two different regions of inside-exterior-surface 3521 may not be readily visible from a top or a bottom view of blanket 2900.

In some embodiments, blanket 2900 (depicted in FIG. 29 through FIG. 46) may comprise flexible soft-and-flexible-book 2917.

FIG. 29 may depict an embodiment of blanket 2900 housing a removable book (e.g., soft-and-flexible-book 2917) from a top perspective view. The embodiment shown in FIG. 29 may be different from the embodiment of FIG. 1 through FIG. 28. FIG. 30 may depict blanket 2900 and a same operational configuration shown in FIG. 29, wherein FIG. 30 may be shown from a top view.

FIG. 29 and FIG. 30 may depict this entertainment system of blanket 2900 with soft-and-flexible-book 2917, but without showing the user, and while blanket 2900 may be in a blanket configuration (e.g., a closed configuration). In such a blanket configuration, blanket 2900 may be folded in half along folded-edge 3019 (see FIG. 30 for folded-edge 3019). As noted, this entertainment system may comprise blanket 2900 and flexible soft-and-flexible-book 2917; wherein soft-and-flexible-book 2917 may be removably attached to blanket 2900.

In some applications of use of this entertainment system, the user may be a child. When this entertainment system may be in use as a blanket 2900 or in use as a blanket 2900 combined with removable soft-and-flexible-book 2917, substantially some portions of the user may be disposed beneath blanket 2900. Such portions of the user may comprise feet, legs, and some torso (waist) portions of the user; with at least some upper body portions of the user remaining uncovered as to read soft-and-flexible-book 2917 while maintaining the lower body of the user comfortable and/or warm. When this entertainment system may be in use as the blanket 2900 combined with removable soft-and-flexible-book 2917, substantially some portions of the user may be disposed beneath blanket 2900 and flexible soft-and-flexible-book 2917 may be laying on top of portions of blanket 2900.

In some embodiments, blanket 2900 may be substantially soft, flexible, and a planar member comprising two opposing major surfaces, a top-exterior-layer 2901 and an opposing inside-exterior-surface 3521; wherein these two opposing major surfaces are substantially bound by an edge 2907 that substantially circumscribes a periphery of blanket 2900. In some embodiments, soft-and-flexible-book 2917 may comprise a flexible-top-cover 3525, a flexible-bottom-cover 4733, one or more flexible-pages 3527, and a book-binding 3523; wherein flexible-top-cover 3525, the one or more flexible-pages 3527, and flexible-bottom-cover 4733 may be attached to book-binding 3523; wherein the one or more flexible-pages 3527 may be disposed between flexible-top-cover 3525 and flexible-bottom-cover 4733; wherein flexible-top-cover 3525 and flexible-bottom-cover 4733 may be opposing to each other. In some embodiments, when blanket 2900 may fold over in half on itself, forming a folded blanket configuration, to create a folder region wherein two halves of inside-exterior-surface 3521 may then face each other; wherein the soft-and-flexible-book 2917 may be removably attached to one half of inside-exterior-surface 3521.

In some embodiments, blanket 2900 may be a blanket for providing warmth and/or comfort to the user. As such a blanket, blanket 2900 may be substantially comprised of one or more types of soft fabrics and/or textiles. Such fabrics and/or textiles may be natural and/or synthetic, or blends thereof. In terms of size, in some embodiments, blanket 2900 may be sized as a throw and/or sized to function as a bedspread for a standard sized bed, such as but not limited to, a single bed, a twin bed, a full size bed, a queen sized bed, a kind sized bed, a California king sized bed, and the like. In some embodiments, blanket 2900 may be substantially flexible and/or pliable, such that blanket 2900 may naturally, via gravity, drape over portions of the user when blanket 2900 may be disposed over portions of the user. That is, in some embodiments, blanket 2900 may not be rigid nor semi-rigid. That is, blanket 2900 may be more flexible and more pliable than a throw pillow or a head pillow used for sleeping.

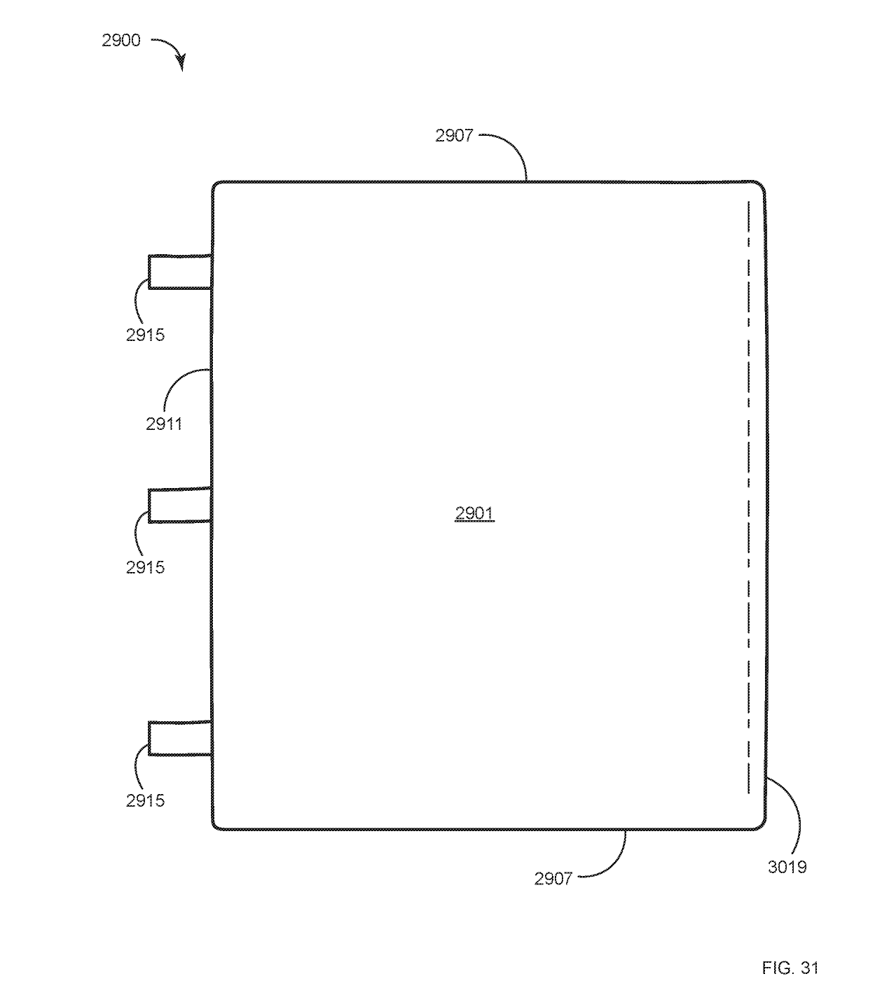

In some embodiments, blanket 2900 may be a substantially flexible, pliable, and/or planar member. When blanket 2900 may be laying upon a substantially flat substrate, blanket 2900 as viewed from above, may be one of the following shapes: a regular polygon, with rounded or without rounded corners; an irregular polygon with rounded or without rounded corners; a square with rounded or without rounded corners; a rectangle with or without rounded corners; an oval; an ellipse, a circle; a semi-circle; and the like. Such shapes may be bounded by edges 2907. See e.g., FIG. 29, FIG. 30, FIG. 31 and FIG. 35. In some embodiments, this shape of a given blanket 2900 may be determined so as to best fit a given bed shape (or mattress shape), which may be generally be rectangular.

In some embodiments, blanket 2900 may be one ply to multiple ply in other embodiments. Regardless of a quantity of plies (i.e., layers), blanket 2900 may comprise a top-exterior-layer 2901 and disposed opposite an inside-exterior-surface 3521 (see FIG. 35 for inside-exterior-surface 3521). In some embodiments, top-exterior-layer 2901 and inside-exterior-surface 3521 may face opposite directions when blanket 2900 may be in a substantially planar configuration (i.e., in an unfolded configuration, such as shown in FIG. 35).

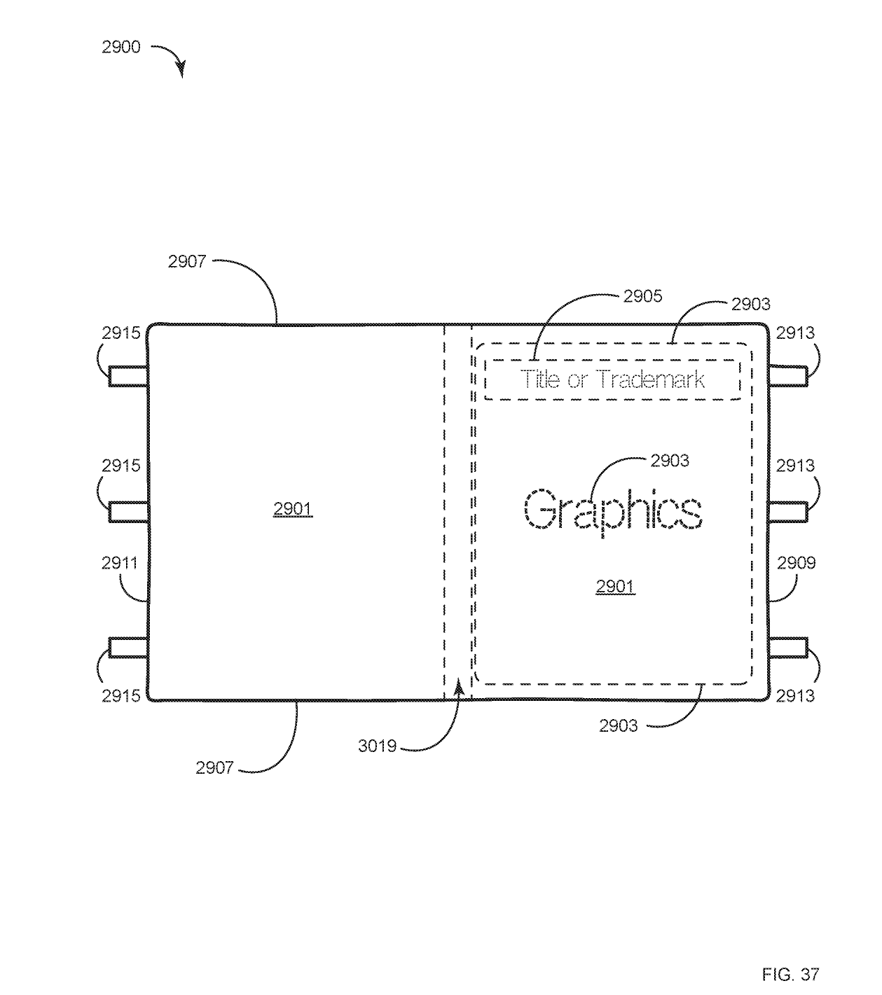

Continuing discussing FIG. 29 and FIG. 30, in some embodiments, top-exterior-layer 2901 may comprise a display-region 2903. See e.g., 29 and 30. In some embodiments, display-region 2903 may display one or more of: a graphic, a scene, a landscape, a logo, a trademark, an image, wording, a copy of a book cover, title-display-region 2905 and/or the like. In some embodiments, display-region 2903 may cover: a majority of top-exterior-layer 2901, half of top-exterior-layer 2901, or less than half of top-exterior-layer 2901. For example, in FIG. 37, display-region 2903 may cover less than half of top-exterior-layer 2901.

Continuing discussing FIG. 29 and FIG. 30, in some embodiments, display-region 2903 may comprise title-display-region 2905; wherein title-display-region 2905 may be a region of display-region 2903 wherein a title and/or a trademark may be displayed. In some embodiments, top-exterior-layer 2901 may comprise title-display-region 2905; wherein title-display-region 2905 may be a region of top-exterior-layer 2901 wherein a title and/or a trademark may be displayed.

Continuing discussing FIG. 29 and FIG. 30, in some embodiments, blanket 2900 may comprise two longitudinally disposed terminal edges, a first-terminal-edge 2909 and a second-terminal-edge 2911. In some embodiments, blanket 2900 may comprise edges 2907. In some embodiments, blanket 2900 may comprise two oppositely disposed terminal edges, first-terminal-edge 2909 and second-terminal-edge 2911. In some embodiments, edge 2907 may comprise first-terminal-edge 2909 and second-terminal-edge 2911. That is, first-terminal-edge 2909 and second-terminal-edge 2911 may be particular types of edges 2907, that may be oppositely disposed from each other in the unfolded blanket configuration shown in FIG. 35 and in FIG. 41.

Continuing discussing FIG. 29 and FIG. 30, when blanket 2900 may be in the folded blanket configuration, first-terminal-edge 2909 and second-terminal-edge 2911 may be substantially aligned (and/or substantially parallel) with each other. In this folded blanket configuration, first-terminal-edge 2909 and second-terminal-edge 2911 may be proximate to each other. In some embodiments, this proximate distance between first-terminal-edge 2909 and second-terminal-edge 2911, when blanket 2900 may be in the folded blanket configuration may be within six inches of each other.

Continuing discussing FIG. 29 and FIG. 30, when blanket 2900 may be in the folded blanket configuration, in some embodiments, first-terminal-edge 2909 may be removably connected to second-terminal-edge 2911 in at least one shared location along at least some portion of first-terminal-edge 2909 and of second-terminal-edge 2911 by an edge sealing means. In some embodiments, this edge sealing means may comprise at least one flap 2913 and at least one complimentary-flap 2915. See e.g., FIG. 29. In some embodiments, at least one flap 2913 may protrude (extend) from first-terminal-edge 2909; and at least one complimentary-flap 2915 may protrude (extend) from second-terminal-edge 2911. See e.g., FIG. 29. Each such flap 2913 and each such complimentary flap 2915 may comprise attachment means for removable attachment between respective pairs of flap 2913 and complimentary-flap 2915. In some embodiments, first-terminal-edge 2909 may comprise one or more flaps 2913; wherein second-terminal-edge 2911 may comprise one or more complimentary-flaps 2915 in a same quantity as a quantity of the one or more flaps 2913; wherein the one or more flaps 2913 may be removably attachable to the one or more complimentary-flaps 2915. Such attachment means may comprise one or more types of mechanical fasteners, such as, but not limited to: zippers, Velcro (i.e., plurality of hooks with complimentary plurality of loops), snap closures, buttons, tie strings, and/or the like.

Alternatively, in some embodiments, the edge sealing means may be located on first-terminal-edge 2909 and on second-terminal-edge 2911; wherein the edge sealing means may comprise one or more types of mechanical fasteners, such as, but not limited to: zippers, Velcro (i.e., plurality of hooks with complimentary plurality of loops), snap closures, buttons, tie strings, and/or the like.

Whereas, in the unfolded configuration, first-terminal-edge 2909 may be oppositely disposed from second-terminal-edge 2911, such that blanket 2900 may not be folded along folded-edge 3019. See e.g., FIG. 35 and FIG. 41. In some embodiments, in the unfolded configuration, at least a portion of top-exterior-layer 2901 may be located above and facing at least some lower body portion of the user and flexible soft-and-flexible-book 2917 may be located above about half of inside-exterior-surface 3521, see e.g., FIG. 35.

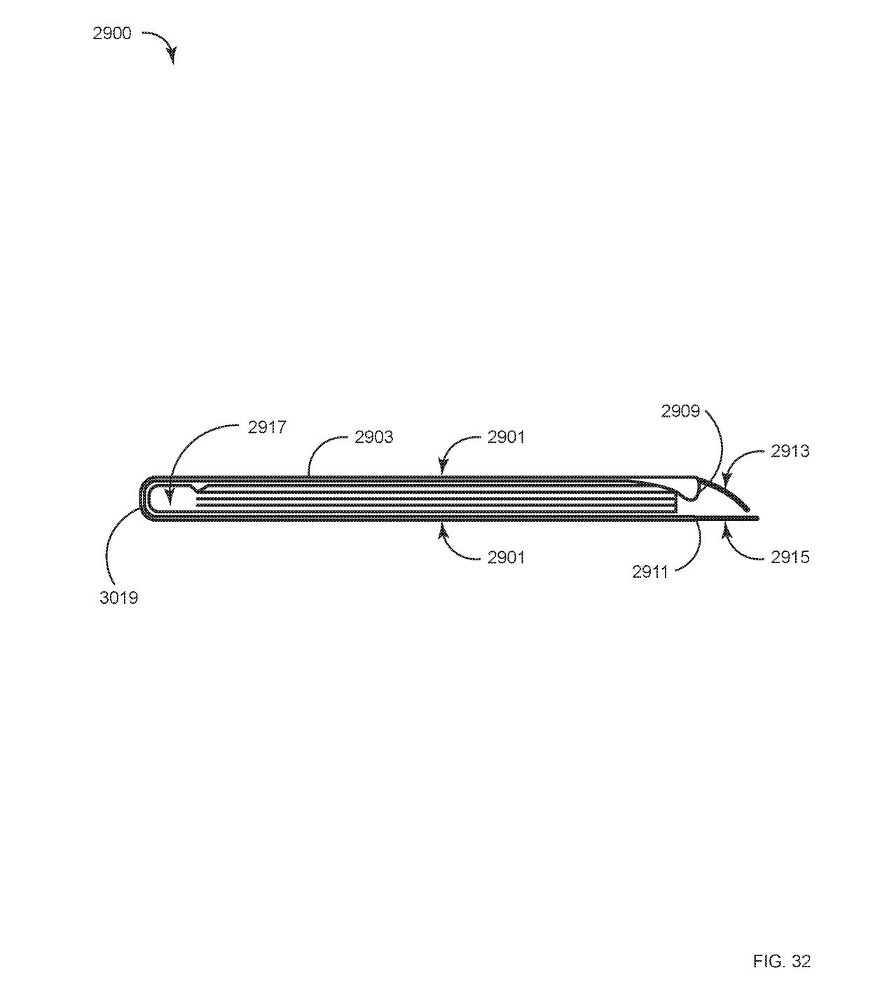

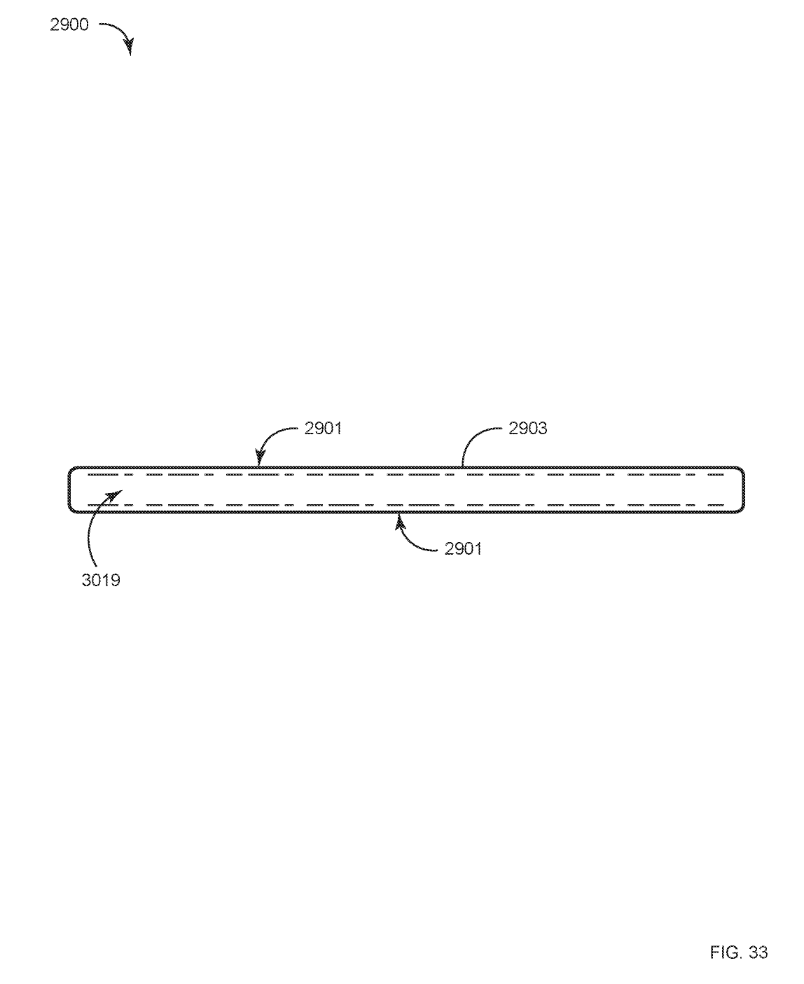

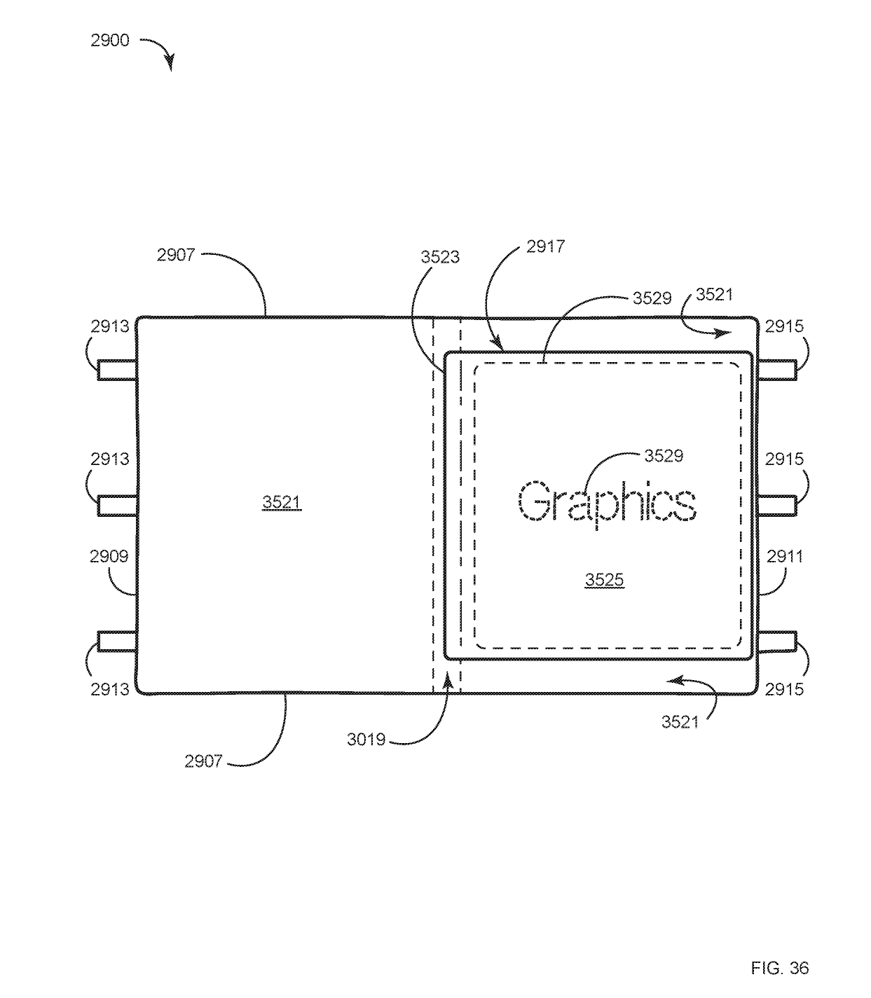

FIG. 30 may be a first figure depicting a portion of folded-edge 3019. See also FIG. 32, FIG. 33, FIG. 35, and FIG. 36 showing other portions of folded-edge 3019. Folded-edge 3019 may be where about one half of blanket 2900 may be folded over to create the folder structure for removably housing soft-and-flexible-book 2917. In some embodiments, folded-edge 3019 may delineate about one half of top-exterior-layer 2901 from the other about half of top-exterior-layer 2901. In some embodiments, folded-edge 3019 may delineate about one half of inside-exterior-surface 3521 from the other about half of inside-exterior-surface 3521. Folded-edge 3019 may be where substantially one half of blanket 2900 may be folded over to create the folder structure for removably housing soft-and-flexible-book 2917. In some embodiments, folded-edge 3019 may delineate substantially one half of top-exterior-layer 2901 from the other substantially half of top-exterior-layer 2901. In some embodiments, folded-edge 3019 may delineate substantially one half of inside-exterior-surface 3521 from the other substantially half of inside-exterior-surface 3521.

FIG. 31 may depict blanket 2900 and the same operational configuration shown in FIG. 29 (i.e., the folded blanket configuration), wherein FIG. 31 may be shown from a bottom view. FIG. 31 may be an opposing view to FIG. 30.

FIG. 32 may depict blanket 2900 and the same operational configuration shown in FIG. 29 (i.e., the folded blanket configuration), wherein FIG. 32 may be shown from a front view (or from a back view, which may be substantially symmetrical to the front view). FIG. 32 may show the folded blanket configuration, with soft-and-flexible-book 2917 removably residing with the folder of folded blanket 2900. In FIG. 32, soft-and-flexible-book 2917 may be closed.

FIG. 33 may depict blanket 2900 and the same operational configuration shown in FIG. 29 (i.e., the folded blanket configuration), wherein FIG. 33 may be a left-side view.

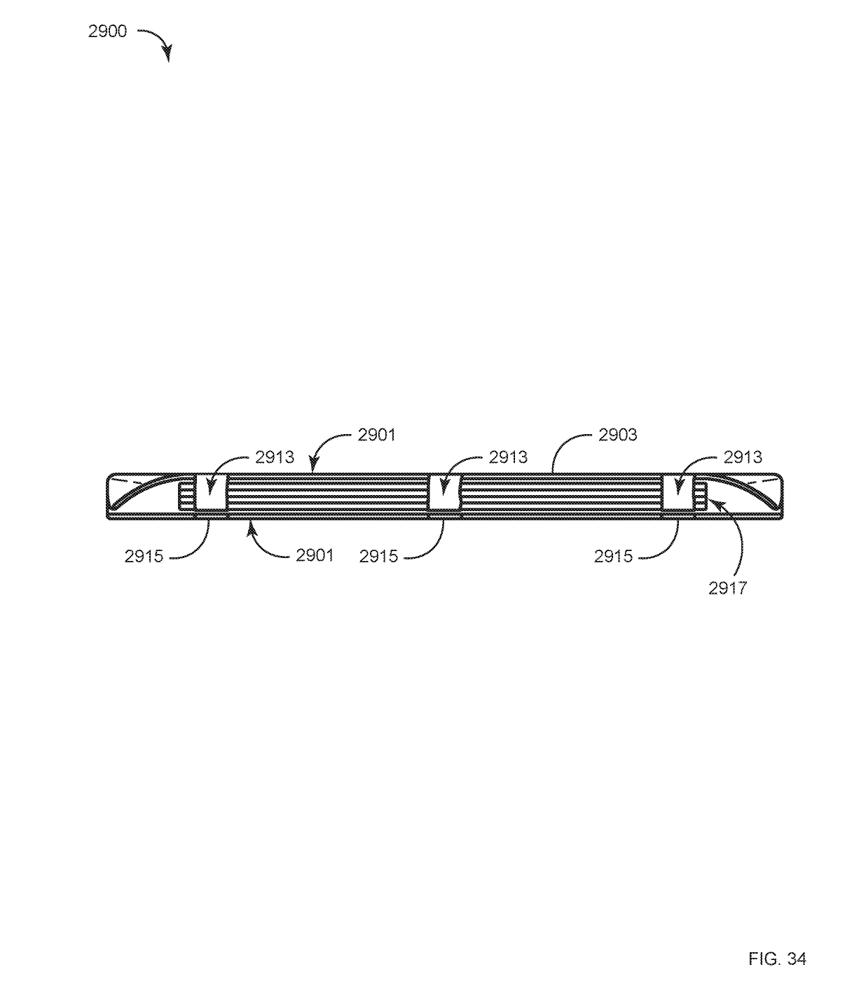

FIG. 34 may depict blanket 2900 and the same operational configuration shown in FIG. 29 (i.e., the folded blanket configuration), wherein FIG. 34 may be a right-side view. FIG. 34 may be an opposing view to FIG. 33. FIG. 34 may show the folded blanket configuration, with soft-and-flexible-book 2917 removably residing with the folder of folded blanket 2900. In FIG. 34, soft-and-flexible-book 2917 may be closed.

FIG. 35 may depict the embodiment of FIG. 29, but from a different operational configuration as shown in FIG. 29; wherein in FIG. 35, the blanket may be unfolded into an open blanket configuration showing the book, wherein the book may be in a closed configuration, shown from a top perspective view.

FIG. 35 may depict this entertainment system of blanket 2900 with removable soft-and-flexible-book 2917, but without showing the user, and while blanket 2900 may be in an unfolded blanket configuration (i.e., an open blanket configuration), while soft-and-flexible-book 2917 may be still in a closed book configuration, shown from a top perspective view. Whereas, FIG. 41 may depict this entertainment system of blanket 2900 with removable soft-and-flexible-book 2917, without showing the user, and while blanket 2900 may be in the unfolded configuration, and while soft-and-flexible-book 2917 may be in an open book configuration, shown from a top perspective view.

FIG. 36 may depict the embodiment of FIG. 29 and the operational configuration of FIG. 35, wherein FIG. 36 may be shown from a top view.

FIG. 35 and FIG. 36 may depict soft-and-flexible-book 2917, with soft-and-flexible-book 2917 closed, and shown from a top view showing a flexible-top-cover 3525 of soft-and-flexible-book 2917. Whereas, FIG. 41 may depict soft-and-flexible-book 2917 of FIG. 1A, with soft-and-flexible-book 2917 open, showing flexible-pages 3527 of soft-and-flexible-book 2917, from a top perspective view.

In some embodiments, soft-and-flexible-book 2917 may be removably attached to blanket 2900. In some embodiments, soft-and-flexible-book 2917 may be stored within “the folder” of blanket 2900 when blanket 2900 may be in the folded blanket configuration, wherein soft-and-flexible-book 2917 may be located disposed between the two different regions of inside-exterior-surface 3521. See e.g., FIG. 29.

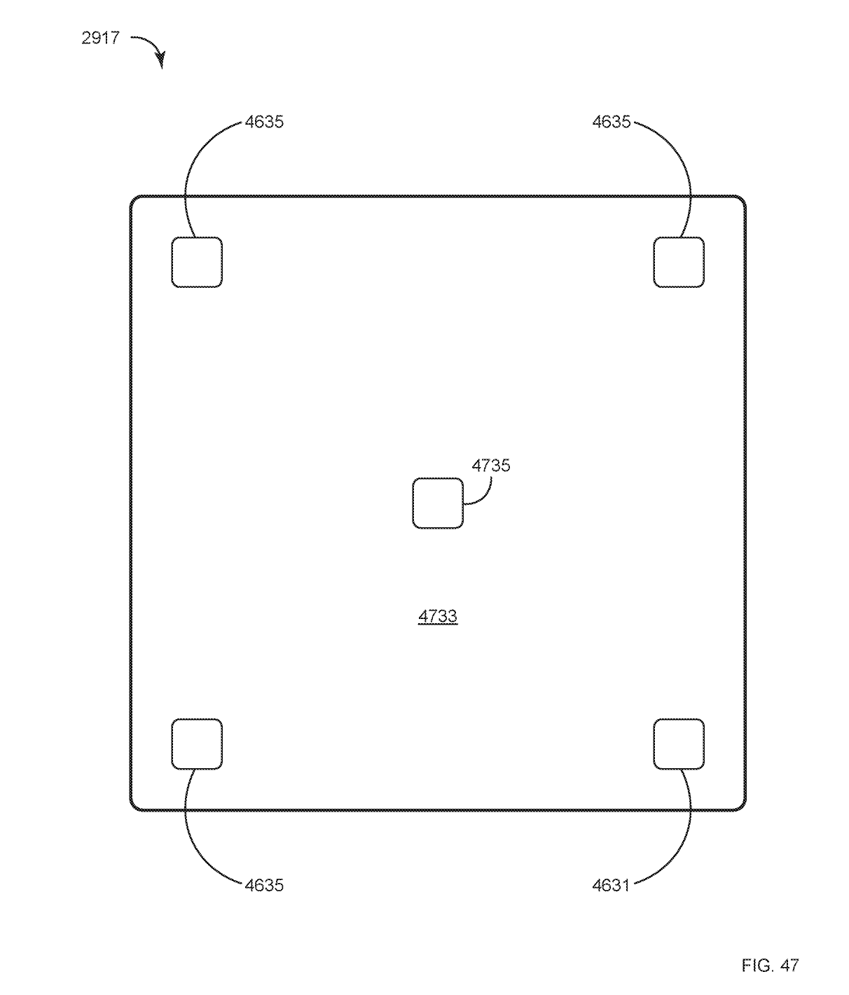

Continuing discussing FIG. 35 and FIG. 36, in some embodiments, soft-and-flexible-book 2917 may comprise a flexible-top-cover 3525, flexible-bottom-cover 4733, one or more flexible-pages 3527, and book-binding 3523. In some embodiments, flexible-top-cover 3525 and flexible-bottom-cover 4733 may function as a book cover to a book. In some embodiments, disposed within and between flexible-top-cover 3525 and flexible-bottom-cover 4733 may be one or more flexible-pages 3527. In some embodiments, one or more flexible-pages 3527 may attach to book-binding 3523 to form a spine of soft-and-flexible-book 2917. See FIG. 35 and FIG. 36 for flexible-top-cover 3525. See FIG. 35 and FIG. 41 for examples of one or more flexible-pages 3527. And see FIG. 47 for flexible-bottom-cover 4733. In some embodiments, one or more flexible-pages 3527 may be attached within and between flexible-top-cover 3525 and flexible-bottom-cover 4733 to form soft-and-flexible-book 2917. In some embodiments, such page attachment may be from a seam, i.e., a fabric seam, such as a sewn seam. Depending upon the flexible and pliable materials of construction for soft-and-flexible-book 2917, this seam that forms book-binding 3523 (i.e., the spine of the book) may also be formed by one or more of: mechanical fasteners, chemical adhesives, solvent bonding, ultrasonic welding, and/or heat welding. In some embodiments, flexible-top-cover 3525, flexible-bottom-cover 4733, and one or more flexible-pages 3527 may each be comprised of one or more fabrics and/or textiles. In some embodiments, flexible-top-cover 3525, flexible-bottom-cover 4733, and one or more flexible-pages 3527 may each be substantially constructed from one or more fabrics and/or textiles. Such soft-and-flexible-book 2917 fabrics and/or textiles may be the same or different from the fabrics and/or textiles substantially forming blanket 2900. In some embodiments, flexible-top-cover 3525, flexible-bottom-cover 4733, and one or more flexible-pages 3527 may each be comprised of one or more types of flexible and pliable plastic sheets. In some embodiments, soft-and-flexible-book 2917 may be rollable and/or foldable.

In some embodiments, flexible-top-cover 3525, flexible-bottom-cover 4733, and the one or more flexible-pages 3527 may be all soft and substantially constructed from one or more fabrics.

Continuing discussing FIG. 35 and FIG. 36, in some embodiments, flexible-top-cover 3525 may comprise graphics 3529. In some embodiments, graphics 3529 may be an external region on flexible-top-cover 3525. In some embodiments, this graphics 3529 may display one or more of: a graphic, a scene, a landscape, a logo, a trademark, an image, wording, a copy of a book cover, and/or the like. In some embodiments, graphics 3529 may cover: substantially all of flexible-top-cover 3525; a majority of flexible-top-cover 3525; half of flexible-top-cover 3525; or less than half of flexible-top-cover 3525.

FIG. 37 may depict blanket 2900 and the operational configuration of FIG. 35 (i.e., the unfolded blanket configuration), wherein FIG. 37 may be shown from a bottom view. FIG. 37 may be an opposing view to FIG. 36.

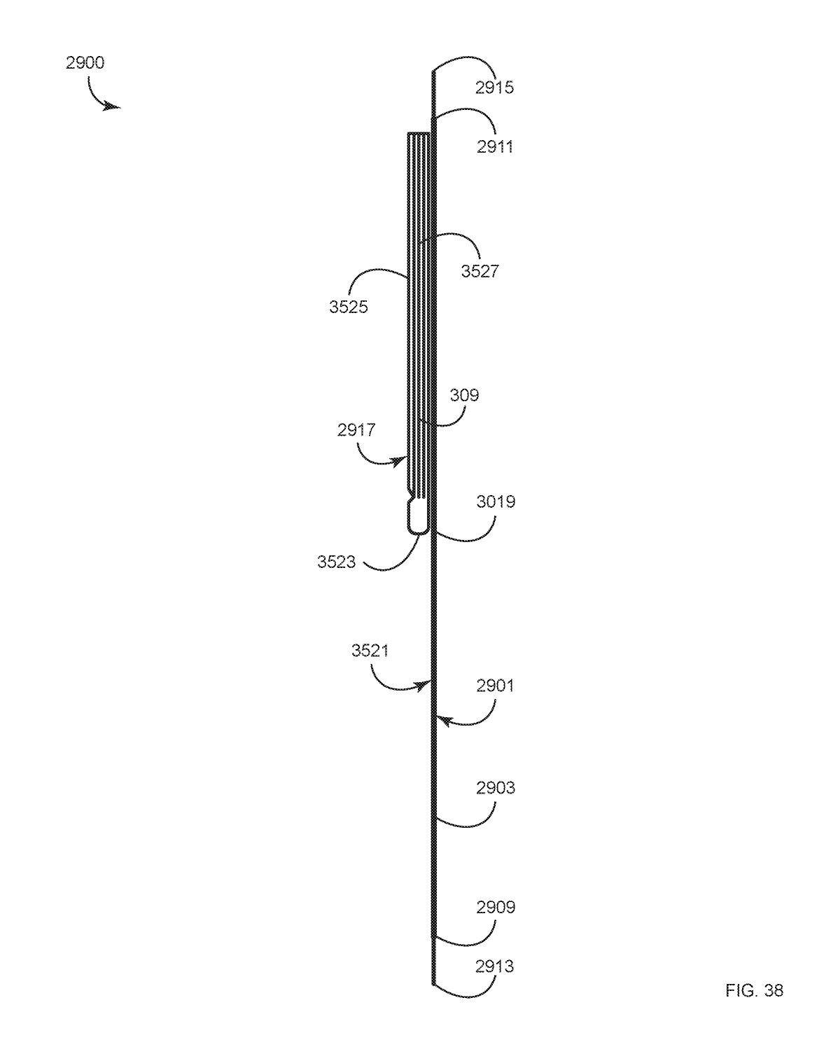

FIG. 38 may depict blanket 2900 and the operational configuration of FIG. 35 (i.e., the unfolded blanket configuration), wherein FIG. 38 may be shown from a front view (or from a back view, which may be substantially symmetrical to the front view). In FIG. 38, soft-and-flexible-book 2917 may be residing on top of a portion of inside-exterior-surface 3521. In FIG. 38, soft-and-flexible-book 2917 may be removably attached to a portion of inside-exterior-surface 3521.

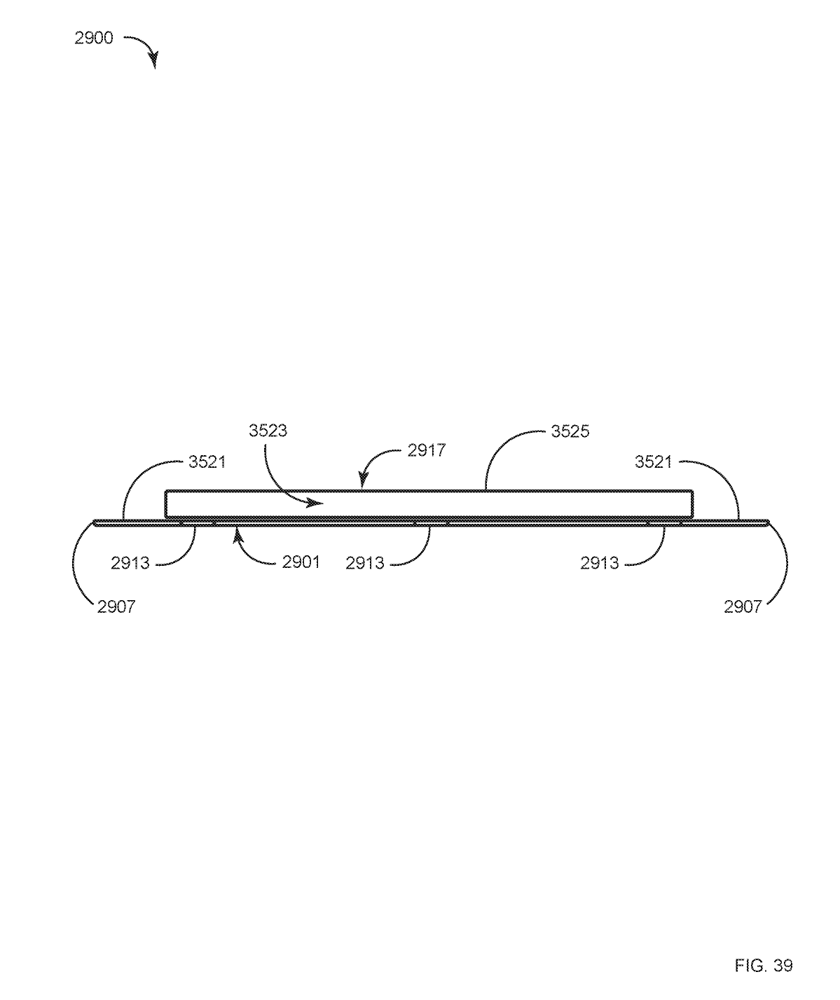

FIG. 39 may depict blanket 2900 and the operational configuration of FIG. 35 (i.e., the unfolded blanket configuration), wherein FIG. 39 may be a left-side view. In FIG. 39, soft-and-flexible-book 2917 may be residing on top of a portion of inside-exterior-surface 3521. In FIG. 39, soft-and-flexible-book 2917 may be removably attached to a portion of inside-exterior-surface 3521.

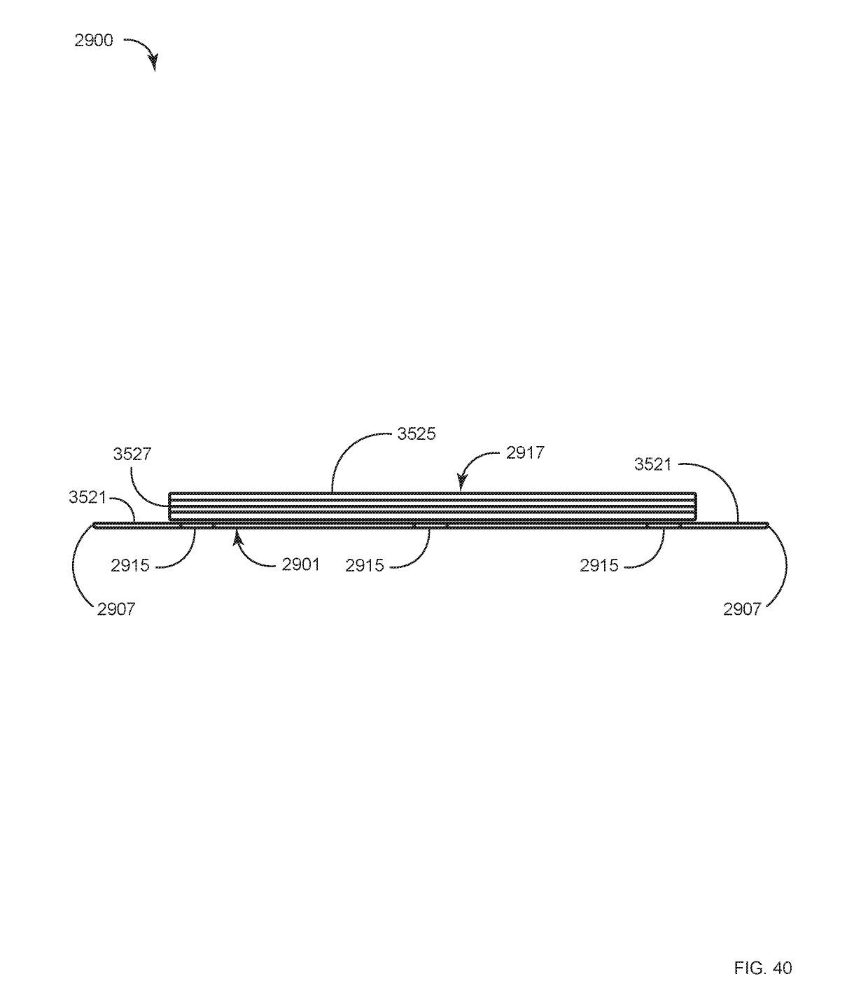

FIG. 40 may depict blanket 2900 and the operational configuration of FIG. 35 (i.e., the unfolded blanket configuration), wherein FIG. 40 may be a right-side view. FIG. 40 may be an opposing view to FIG. 39. In FIG. 40, soft-and-flexible-book 2917 may be residing on top of a portion of inside-exterior-surface 3521. In FIG. 40, soft-and-flexible-book 2917 may be removably attached to a portion of inside-exterior-surface 3521.

FIG. 41 may depict blanket 2900, but from a different operational configuration as shown in FIG. 35 and different from FIG. 29; wherein in FIG. 41, blanket 2900 may be unfolded into the open blanket configuration or the unfolded blanket configuration showing soft-and-flexible-book 2917, wherein soft-and-flexible-book 2917 may be in an open book configuration, shown from a top perspective view. In FIG. 41, a soft, flexible, and pliable nature of flexible-pages 3527 (of soft-and-flexible-book 2917) may be evident. In some embodiments, flexible-pages 3527 may be substantially constructed from soft, flexible, and pliable fabrics and/or textiles.

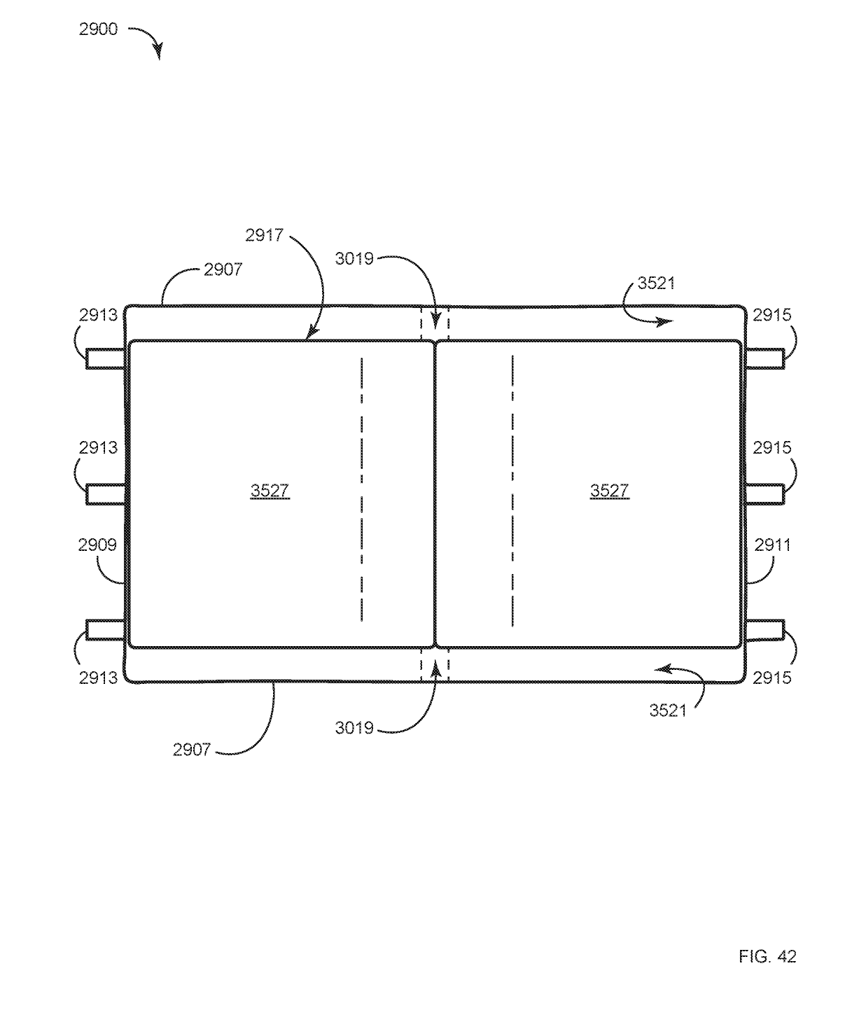

FIG. 42 may depict blanket 2900 and the operational configuration of FIG. 41, wherein FIG. 42 may be shown from a top view.

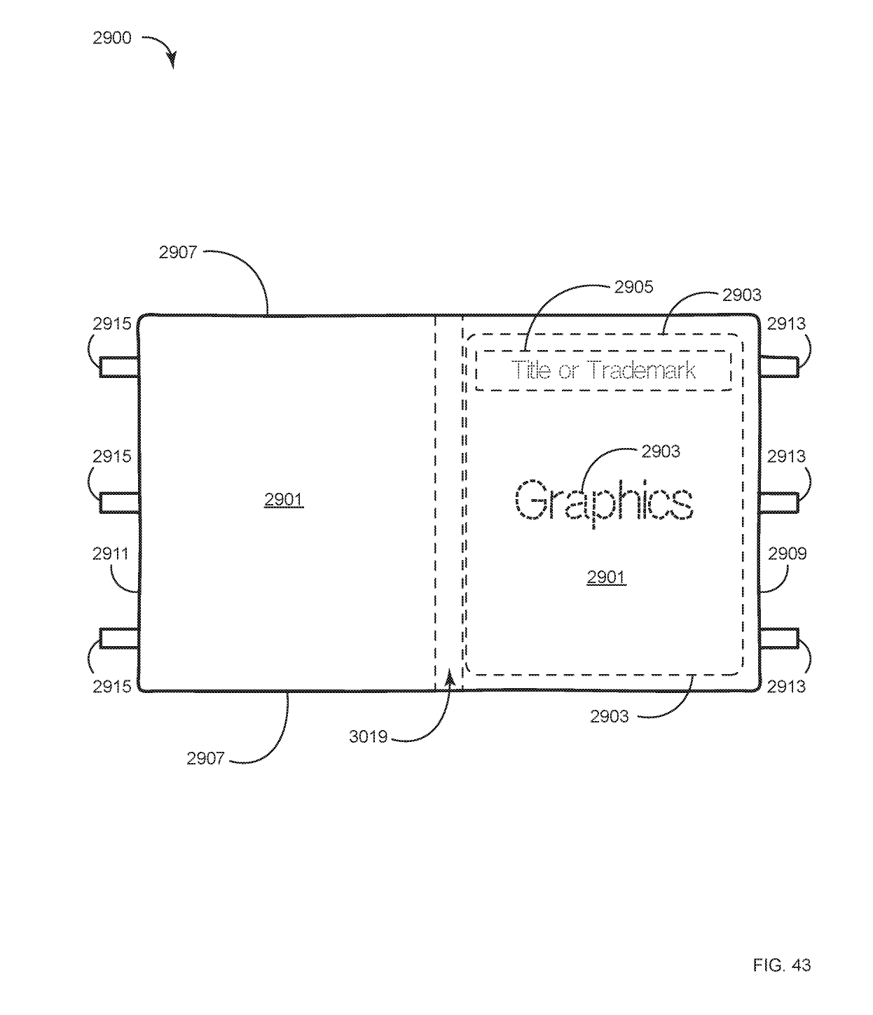

FIG. 43 may depict blanket 2900 and the operational configuration of FIG. 41, wherein FIG. 43 may be shown from a bottom view. FIG. 43 may be an opposing view to FIG. 42.

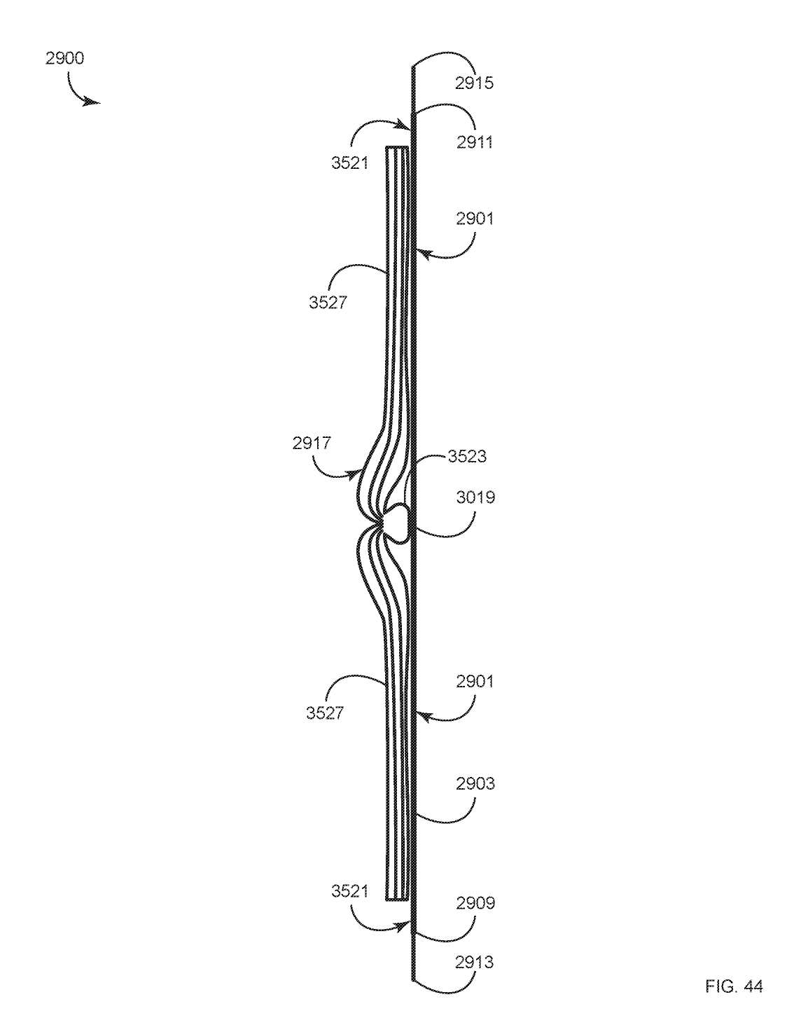

FIG. 44 may depict blanket 2900 and the operational configuration of FIG. 41, wherein FIG. 44 may be shown from a front view (or from a back view, which may be substantially symmetrical to the front view).

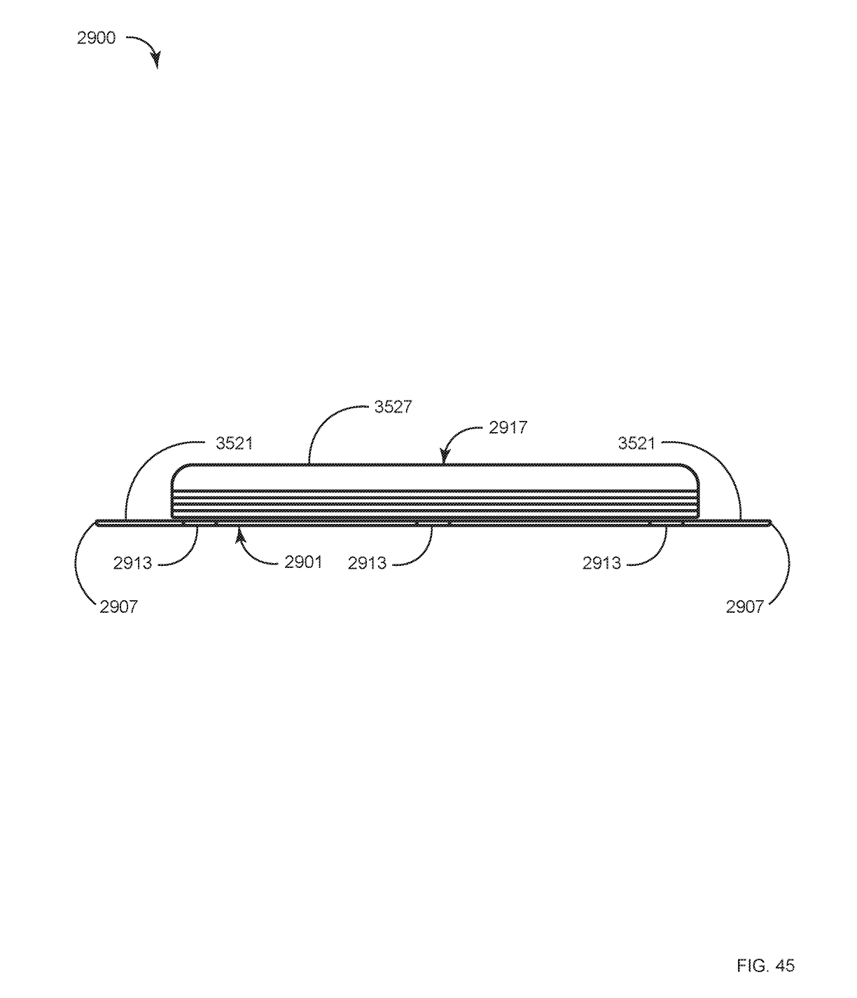

FIG. 45 may depict blanket 2900 and the operational configuration of FIG. 41, wherein FIG. 45 may be a side view (either a left-side view or a right-side view due to symmetry). Technically, FIG. 45 may depict the left-side view since the flaps 2913 are shown. In a right-side view these flaps 2913 would be replaced with the complimentary-flaps 2915.

In the operational configuration depicted in FIG. 41 through FIG. 45, soft-and-flexible-book 2917 may be open and residing on top of blanket 2900, such as on top of portions of inside-exterior-surface 3521.

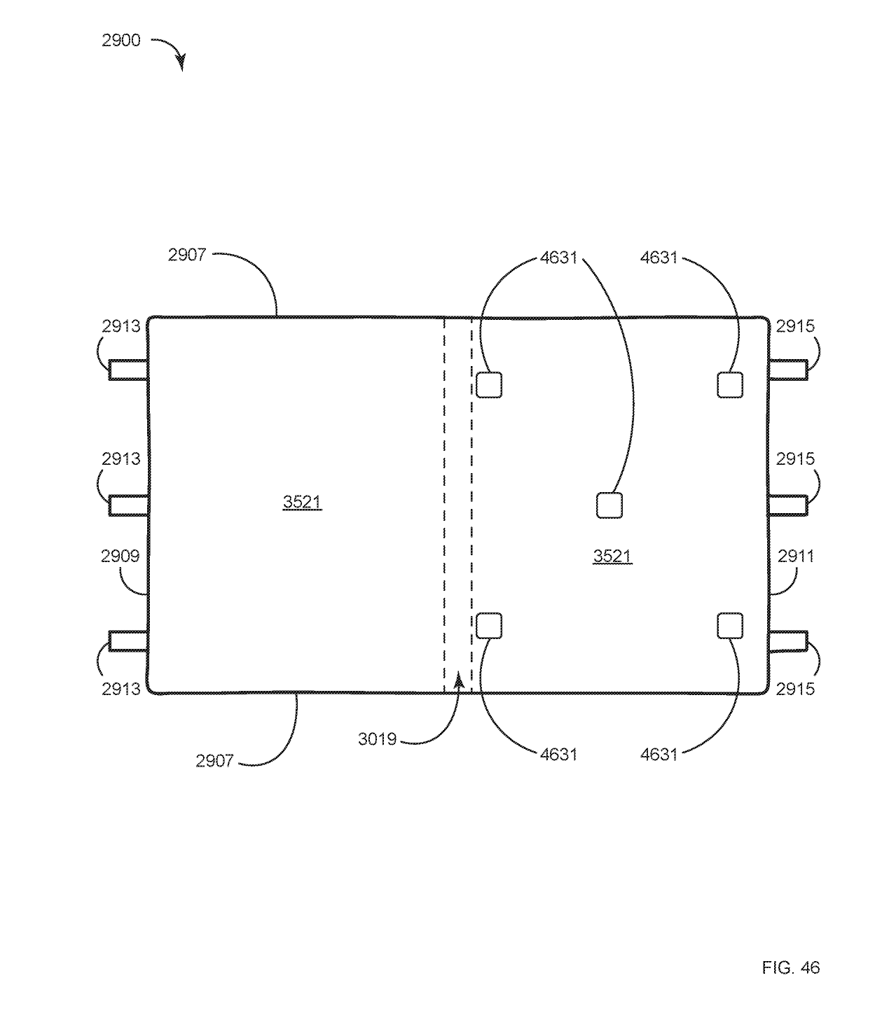

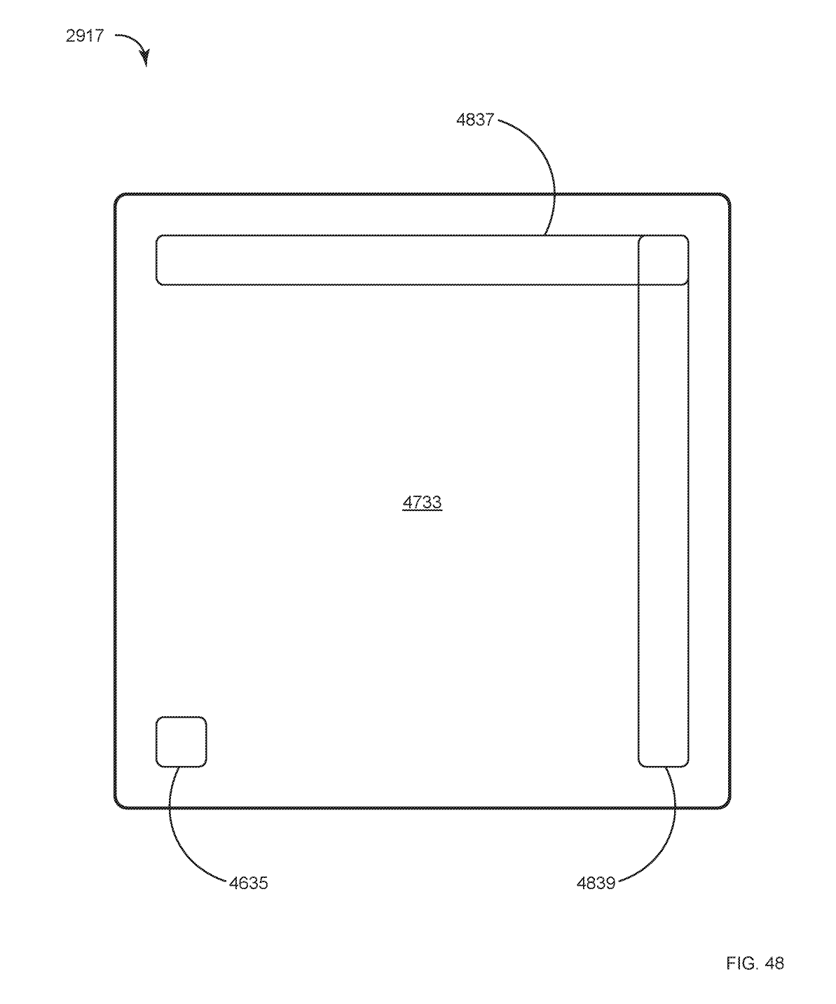

FIG. 46 may depict a top view similar to that of FIG. 36 or of FIG. 42, but in FIG. 46 soft-and-flexible-book 2917 may not be shown. FIG. 46 may depict blanket 2900, without showing the user and without depicting soft-and-flexible-book 2917, and while blanket 2900 may be in the unfolded configuration, shown from a top perspective view. In FIG. 46, soft-and-flexible-book 2917 may be removably detached from blanket 2900. In FIG. 46, folded-edge 3019 may delineate each of the two different regions of inside-exterior-surface 3521 from each other. Each such region of inside-exterior-surface 3521 may be about half of the total inside-exterior-surface 3521. And disposed and attached on at least one of these regions of inside-exterior-surface 3521, may be at least one complimentary blanket-to-book-fastener 4631. In some embodiments, at least one complimentary blanket-to-book-fastener 4631 may removably attach to at least one book-to-blanket-fastener (4735, 4837, and/or 4839—see e.g., FIG. 47 and FIG. 48) located on flexible-bottom-cover 4733 of soft-and-flexible-book 2917. Note, while discrete regions of complimentary blanket-to-book-fastener 4631 may be shown on one of the regions of inside-exterior-surface 3521 in FIG. 46, an actual pattern of complimentary blanket-to-book-fastener 4631 may match such a complimentary pattern of book-to-blanket-fastener (4735, 4837, and/or 4839) on flexible-bottom-cover 4733. In some embodiments, each complimentary blanket-to-book-fastener 4631 may comprise one or more types of mechanical fasteners, such as, but not limited to: zippers, Velcro (i.e., plurality of hooks with complimentary plurality of loops), snap closures, buttons, tie strings, and/or the like.

FIG. 47 may depict a bottom (exterior) cover of the book (e.g., soft-and-flexible-book 2917) of FIG. 29 through FIG. 45. That is, FIG. 47 may depict an embodiment of flexible-bottom-cover 4733. FIG. 48 may depict another bottom (exterior) cover of the book (e.g., soft-and-flexible-book 2917) of FIG. 29 through FIG. 45. That is, FIG. 48 may depict another embodiment of flexible-bottom-cover 4733.

FIG. 47 may depict flexible soft-and-flexible-book 2917, with soft-and-flexible-book 2917 closed, and shown from a bottom view showing flexible-bottom-cover 4733. FIG. 48 may depict flexible soft-and-flexible-book 2917, with soft-and-flexible-book 2917 closed, and shown from a bottom view showing flexible-bottom-cover 4733. FIG. 47 and FIG. 48 may differ, in the type and pattern (arrangement) of book-to-blanket-fastener (4735, 4837, and/or 4839) attached to flexible-bottom-cover 4733.

Continuing discussing FIG. 47 and FIG. 48, in some embodiments, flexible soft-and-flexible-book 2917 may comprise flexible-top-cover 3525 and opposing flexible-bottom-cover 4733. In some embodiments, flexible-bottom-cover 4733 may comprise book-to-blanket-fastener (4735, 4837, and/or 4839). In some embodiments, book-to-blanket-fastener (4735, 4837, and/or 4839) may be located on flexible-bottom-cover 4733 (see e.g., FIG. 47 and FIG. 48). In some embodiments, book-to-blanket-fastener (4735, 4837, and/or 4839) may be permanently attached to flexible-bottom-cover 4733 (see e.g., FIG. 47 and FIG. 48). In some embodiments, book-to-blanket-fastener (4735, 4837, and/or 4839) may removably attach to a portion of inside-exterior-surface 3521 (see FIG. 35 and FIG. 46) of blanket 2900. In some embodiments, this portion of inside-exterior-surface 3521 may occupy half or less than half of inside-exterior-surface 3521. This portion of inside-exterior-surface 3521 may comprise complimentary blanket-to-book-fasteners 4631, which may removably attach with book-to-blanket-fastener (4735, 4837, and/or 4839). See e.g., FIG. 46 for this portion of portion of inside-exterior-surface 3521 that may comprise complimentary blanket-to-book-fasteners 4631.

In some embodiments, book-to-blanket-fastener (4735, 4837, and/or 4839) may comprise one or more types of mechanical fasteners, such as, but not limited to: zippers, Velcro (i.e., plurality of hooks with complimentary plurality of loops), snap closures, buttons, tie strings, and/or the like.

Book-to-blanket-fastener 4735 may be shown in FIG. 47 and in FIG. 48. Book-to-blanket-fastener 4837 and book-to-blanket-fastener 4839 may be shown in FIG. 48. Book-to-blanket-fastener 4837 and book-to-blanket-fastener 4839 may be strips of attachment means; whereas, book-to-blanket-fastener 4735 may be a patch or region of attachment means. Book-to-blanket-fastener 4837 may be a strip running from a spine side of flexible soft-and-flexible-book 2917 away from the spine. Book-to-blanket-fastener 4837 may be a strip running from a book-binding 3523 side of soft-and-flexible-book 2917 away from book-binding 3523. Whereas, book-to-blanket-fastener 4839 may be a strip that may be substantially parallel with the spine of soft-and-flexible-book 2917. Book-to-blanket-fastener 4839 may be a strip that may be substantially parallel with book-binding 3523 of soft-and-flexible-book 2917. In some embodiments, such strips (for 4837 and/or 4839) may be strips of: zippers, Velcro (i.e., plurality of hooks with complimentary plurality of loops), snap closures, buttons, tie strings, and/or the like.

In some embodiments, blanket-to-book-fasteners 4631 and the book-to-blanket-fasteners (e.g., 4735, 4837, and/or 4839) may be complimentary mechanical fasteners selected from one or more of: buttons; Velcro (e.g., plurality of hooks and complimentary plurality of loops to removably attach to the plurality of hooks); zippers; ties; snap buttons; press buttons; zip-locks; press-fits; and/or the like.

In terms of patterns and/or coverage, flexible-bottom-cover 4733 may comprise at least one book-to-blanket-fasteners (4735, 4837, and/or 4839). In some embodiments, flexible-bottom-cover 4733 may comprise a quantity of book-to-blanket-fastener 4735 matching a number of corners of flexible-bottom-cover 4733 (e.g., with four corners), with one book-to-blanket-fastener 4735 located at or proximate (e.g., within three inches) to each corner of flexible-bottom-cover 4733. See e.g., FIG. 47. FIG. 48 may illustrate that different types of book-to-blanket-fasteners (4735, 4837, and/or 4839) may be attached to flexible-bottom-cover 4733 and in different patterns and/or arrangements.

And the quantity, pattern, and/or arrangement of book-to-blanket-fasteners (4735, 4837, and/or 4839) located and attached to flexible-bottom-cover 4733 may have a complimentary quantity, pattern, and/or arrangement of complimentary blanket-to-book-fasteners 4631 on the portion of inside-exterior-surface 3521. See e.g., FIG. 46.

Note, in some embodiments, the spine of flexible soft-and-flexible-book 2917 may not be removably attachable to blanket 2900. Note, in some embodiments, book-binding 3523 of flexible soft-and-flexible-book 2917 may not be removably attachable to blanket 2900.

Note, FIG. 1 through FIG. 28 may depict the same embodiment, but may depict different operational configurations of that embodiment. Similarly, FIG. 29 through FIG. 46 may depict a same embodiment, but a different embodiment from FIG. 1 through FIG. 28; however, this same embodiment of FIG. 29 through FIG. 46 may show different operational configurations.

Note, soft-and-flexible-book 723 may differ from soft-and-flexible-book 2917 in how each respective flexible book removably attaches to its respective blanket (100 or 2900, respectively). Each such soft-and-flexible-book (723 and 2917) may use attachment means located on the respective soft-and-flexible-book's flexible-bottom-cover (1035 and 4733, respectively). Flexible soft-and-flexible-book 723 may removably attach to blanket 100 via use of tether 833. Flexible soft-and-flexible-book 2917 may removably attach directly to blanket 2900 (via complimentary blanket-to-book-fasteners 4631 and book-to-blanket-fasteners [4735, 4837, and/or 4839]). Storage of soft-and-flexible-book 723 may utilize at least one pocket 415 of blanket 100. Storage of soft-and-flexible-book 2917 may utilize “the folder” of the folded blanket configuration of blanket 2900.

In various embodiments, the blankets (e.g., 100 and 2900); the soft-and-flexible-books (e.g., 723 and 2917), including the flexible-top-covers (e.g., 825 and 3525) and the flexible-pages (e.g., 829 and 3527); pockets 415; and/or tethers 833 may be substantially constructed of one or more fabrics and/or textiles. Such fabrics and/or textiles may be natural, synthetics, blends thereof, and the like. Such fabrics and/or textiles may be of different fabrics and/or textiles for these various different component parts. For example, and without limiting the scope of the present invention, various embodiments of the blankets (e.g., 100 and 2900) may be substantially constructed from fabrics and/or textiles that may be different from the fabrics and/or textiles used to construct the soft-and-flexible-books (e.g., 723 and 2917). For example, and without limiting the scope of the present invention, various embodiments of portions of the blankets (e.g., 100 and 2900) that may be intended for substantial contact with the users may be soft. Whereas, the display-regions (e.g., 103 and 2903); the flexible-top-covers (e.g., 825 and 3525) and the flexible-pages (e.g., 829 and 3527) may be substantially constructed from fabrics and/or textiles with a purpose of showing good graphic image and/or written content resolution; which may mean a smooth surface and/or a high thread count and/or a tight weave.

In various embodiments, the blankets (e.g., 100 and 2900); the soft-and-flexible-books (e.g., 723 and 2917), including the flexible-top-covers (e.g., 825 and 3525) and the flexible-pages (e.g., 829 and 3527); pockets 415; and/or tethers 833 may be substantially constructed of one or more flexible and pliable plastics.

Note with respect to the materials of construction, it is not desired nor intended to thereby unnecessarily limit the present invention by reason of such restricted disclosure.

In some embodiments, a method for entertaining may comprise steps of: detaching a removable soft-and-flexible-book (e.g., 723 or 2917) from a blanket (e.g., 100 or 2900); and then observing (or interacting with) the removable soft-and-flexible-book. In some embodiments, the step of observing the removable flexible book may comprise opening and reading the removable soft-and-flexible-book (e.g., 723 or 2917). In some embodiments, prior to the step of observing the removable soft-and-flexible-book (e.g., 723 or 2917), the method may comprises a step of placing the removable soft-and-flexible-book (e.g., 723 or 2917) on top of an exterior layer (e.g., top-exterior-layer 101 or top-exterior-layer 2901 or inside-exterior-surface 3521 when in the unfolded blanket configuration) of the blanket (e.g., 100 or 2900).

In some embodiments, prior to the step of observing the removable soft-and-flexible-book (e.g., 723 or 2917), the method may comprise a step of locating at least a portion of the blanket (e.g., 100 or 2900) over at least a lower body portion of the user.

In some embodiments, a method for entertaining may comprising steps of: unfolding blanket 2900 that was folded in half, which may reveal removable flexible soft-and-flexible-book 2917; wherein the removable flexible soft-and-flexible-book 2917 may comprise flexible-bottom-cover 4733 that may be removably attached to blanket 2900; and then observing removable flexible soft-and-flexible-book 2917. In some embodiments, the step of observing the removable flexible soft-and-flexible-book 2917 may comprise opening and reading the removable flexible soft-and-flexible-book 2917. In some embodiments, prior to the step of observing removable flexible soft-and-flexible-book 2917, the method may comprise a step of locating at least a portion of blanket 2900 over at least a lower body portion of the user.

In some embodiments, a method for manufacturing blanket 100 with removable soft-and-flexible-book 723, may comprise steps of: building removable soft-and-flexible-book 723 from flexible-top-cover 825, flexible-pages 829, and from flexible-bottom-cover 1035; building flexible pocket 415 in blanket 100 for removable housing of removable soft-and-flexible-book 723; wherein the flexible pocket 415 may comprise at least one opening 417 for accessing the flexible pocket 415; locating and securing flexible pocket 415 between two layers (e.g., top-exterior-layer 101 and bottom-exterior-layer 309) of fabric; forming blanket 100 from the two layers of fabric by sealing substantially all peripheral edges 107 of each of the two layers to each other by a seam forming means; and placing soft-and-flexible-book 723 within the flexible pocket 415. In some embodiments, the method may further comprise a step of removably attaching tether 833 to an interior of the flexible pocket 415 (e.g., to a surface of pocket-cavity 2843); and removably attaching a different portion of the tether 833 to the removable soft-and-flexible-book 723 by using fastener-on-tether 1437 and fastener-on-book 1639.

In some embodiments, a method for manufacturing blanket 2900 with removable soft-and-flexible-book 2917, may comprise steps of: building removable soft-and-flexible-book 2917 from flexible-top-cover 3525, flexible-pages 3527, and from flexible-bottom-cover 4733; forming blanket 2900 from at least one layer of fabric; and removably attaching flexible-bottom-cover 4733 to the at least one layer of fabric by a book-to-blanket fastener (4735, 4837, and/or 4839) located on flexible-bottom-cover 4733 that removably attaches to complimentary blanket-to-book-fasteners 4631. In some embodiments, the method may further comprise removably attaching one terminal edge (e.g., first-terminal-edge 2909) of blanket 2900 to another terminal edge (e.g., second-terminal-edge 2911) of the blanket 2900 by the edge sealing means (e.g., using flaps 2913 and complimentary-flap 2915).

Entertainment systems, blankets with removable flexible books (e.g., the soft-and-flexible-books), methods of use, and methods of manufacturing have been described and disclosed. The foregoing description of the various embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A blanket removably attached to a soft-and-flexible-book, comprising:
the blanket that is substantially soft, flexible, and a planar member; wherein the blanket comprises two opposing major surfaces, a top-exterior-layer and an opposing bottom exterior-layer; wherein these two opposing major surfaces are substantially bound by an edge of the blanket that substantially circumscribes a periphery of the blanket;
the soft-and-flexible-book comprising a flexible-top-cover, a flexible-bottom-cover, one or more flexible-pages, and a book-binding; wherein the flexible-top-cover, the one or more flexible-pages, and the flexible-bottom-cover are attached to the book-binding; wherein the one or more flexible-pages are disposed between the flexible-top-cover and the flexible-bottom-cover; wherein the flexible-top-cover and the flexible-bottom-cover are opposing; and
wherein the soft-and-flexible-book is removably attached to the blanket.

2. The blanket removably attached to the soft-and-flexible-book according to claim 1, wherein the blanket comprises at least one pocket; wherein the at least one pocket comprises a pocket-cavity that is sized to removably house the soft-and-flexible-book; wherein the at least one pocket comprises at least one pocket-opening for providing access to the pocket-cavity.

3. The blanket removably attached to the soft-and-flexible-book according to claim 2, wherein a length of the pocket-cavity that extends substantially parallel with a length of the blanket extends according to a ratio selected from a range of 0.10 to 0.40; wherein this ratio is with respect to the length of the pocket-cavity to the length of the blanket.

4. The blanket removably attached to the soft-and-flexible-book according to claim 2, wherein the least one pocket comprises a pocket-sealer located at the at least one pocket-opening for removably sealing the at least one pocket-opening.

5. The blanket removably attached to the soft-and-flexible-book according to claim 4, wherein the pocket-sealer is a mechanical fastener selected from one or more of: buttons; plurality of hooks and complimentary plurality of loops to removably attach to the plurality of hooks; zippers; ties; snap buttons; press buttons; zip-locks; or press-fits.

6. The blanket removably attached to the soft-and-flexible-book according to claim 2, wherein the least one pocket is disposed between the top-exterior-layer and the bottom-exterior-layer with the at least one pocket-opening located at a portion of the edge.

7. The blanket removably attached to the soft-and-flexible-book according to claim 1, further comprising a tether; wherein the tether is an elongate member that is substantially planar and longer than wide; wherein the tether is flexible; wherein the tether comprises two opposing terminal-ends; wherein one such terminal-end is attached to a pocket-cavity of at least one pocket; wherein the blanket comprises the at least one pocket; and wherein the other remaining terminal-end is removably attached to the soft-and-flexible-book.

8. The blanket removably attached to the soft-and-flexible-book according to claim 7, wherein the flexible-bottom-cover comprises a fastener-on-book that removably attaches to a fastener-on-tether; wherein the tether comprises the fastener-on-tether.

9. The blanket removably attached to the soft-and-flexible-book according to claim 8, wherein the fastener-on-book and the fastener-on-tether are complimentary mechanical fasteners selected from one or more of: buttons; plurality of hooks and complimentary plurality of loops to removably attach to the plurality of hooks; zippers; ties; snap buttons; press buttons; zip-locks; or press-fits.

10. The blanket removably attached to the soft-and-flexible-book according to claim 1, wherein the flexible-top-cover, the flexible-bottom-cover, and the one or more flexible-pages are all soft and substantially constructed from one or more fabrics.

11. The blanket removably attached to the soft-and-flexible-book according to claim 1, wherein the two opposing major surfaces are a shape that is substantially rectangular as viewed orthogonally from above or from below of either of the two opposing major surfaces; wherein these two opposing major surfaces comprise a length and a width defining dimensions of the shape; wherein a ratio of length-to-width of the blanket is selected from a range of 1.1 to 2.2, including endpoints of that ratio range.

12. The blanket removably attached to the soft-and-flexible-book according to claim 1, wherein the top-exterior-layer comprises a display-region; and the flexible-top-cover comprises a graphics region.

13. A blanket removably attached to a soft-and-flexible-book, comprising:
the blanket that is substantially soft, flexible, and a planar member; wherein the blanket comprises two opposing major surfaces, a top-exterior-layer and an opposing inside-exterior-surface; wherein these two opposing major surfaces are substantially bound by an edge of the blanket that substantially circumscribes a periphery of the blanket;
the soft-and-flexible-book comprising a flexible-top-cover, a flexible-bottom-cover, one or more flexible-pages, and a book-binding; wherein the flexible-top-cover, the one or more flexible-pages, and the flexible-bottom-cover are attached to the book-binding; wherein the one or more flexible-pages are disposed between the flexible-top-cover and the flexible-bottom-cover; wherein the flexible-top-cover and the flexible-bottom-cover are opposing; and
wherein when the blanket folds over in half, a folded blanket configuration is formed, forming a folder region wherein two halves of the inside-exterior-surface face each other; wherein the soft-and-flexible-book is removably attached to one half of the inside-exterior-surface.

14. The blanket removably attached to the soft-and-flexible-book according to claim 13, wherein the edge comprises two opposing terminal-edges, a first-terminal-edge and a second-terminal-edge; wherein when the blanket is an unfolded configuration the first-terminal-edge and the second-terminal-edge are opposing to each other; wherein when the blanket is in the folded blanket configuration, the first-terminal-edge and the second-terminal-edge are removably attachable to each other.

15. The blanket removably attached to the soft-and-flexible-book according to claim 14, wherein the first-terminal-edge comprises one or more flaps; wherein the second-terminal-edge comprises one or more complimentary-flaps in a same quantity as a quantity of the one or more flaps; wherein the one or more flaps are removably attachable to the one or more complimentary-flaps.

16. The blanket removably attached to the soft-and-flexible-book according to claim 13, wherein the one half of the inside-exterior-surface comprises blanket-to-book-fasteners; and the flexible-bottom-cover comprises book-to-blanket-fasteners; wherein the blanket-to-book-fasteners are removably attachable to the book-to-blanket-fasteners.

17. The blanket removably attached to the soft-and-flexible-book according to claim 16, wherein the blanket-to-book-fasteners and the book-to-blanket-fasteners are complimentary mechanical fasteners selected from one or more of: buttons; plurality of hooks and complimentary plurality of loops to removably attach to the plurality of hooks; zippers; ties; snap buttons; press buttons; zip-locks; or press-fits.

18. The blanket removably attached to the soft-and-flexible-book according to claim 13, wherein the flexible-top-cover, the flexible-bottom-cover, and the one or more flexible-pages are all soft and substantially constructed from one or more fabrics.

19. The blanket removably attached to the soft-and-flexible-book according to claim 13, wherein the top-exterior-layer comprises a display-region; and the flexible-top-cover comprises a graphics region.
